(19) United States
(12) Patent Application Publication
(10) Pub. No.: US 2008/0086369 A1
(43) Pub. Date: Apr. 10, 2008

(54) Method and apparatus for message campaigns

(75) Inventors: Chun Suen Kiat, San Jose, CA (US); Jonathan Brent Oakes, San Jose, CA (US); Ashish Kumar Antal, Los Gatos, CA (US)

Correspondence Address: MOLLBORN PATENTS, 2840 COLBY DRIVE, BOULDER, CO, 80305, US

(73) Assignee: L2 Solutions, Inc., Palo Alto, CA (US)

(21) Appl. No.: 11/543,530

(22) Filed: Oct. 5, 2006

(51) Int. Cl. G06Q 30/00

(52) U.S. Cl. 705/14

(57) ABSTRACT

One embodiment of the preset invention is a method for managing a message campaign that includes: (a) creating one or more messages to be sent to one or more members of a target audience for the message campaign, wherein the one or more messages comprise address information to be used to provide a response; (b) collecting response information pertaining to one or more members of the target audience that respond to a received message; and (c) associating the response information with the responsive members.

### TECHNICAL FIELD OF THE INVENTION

One or more embodiments of the present invention pertain to communications in commerce. In particular, one or more embodiments of the present invention pertain to method and apparatus: (a) for receiving one or more of the following inputs: (i) a target audience, (ii) a message to convey to individuals in the target audience, and (iii) information to track whenever an individual responds to the message; and (b) utilizing the information to determine one or more of the following: (i) future communications media, (ii) formats for future communications; and (iii) the substance of future communications.

### BACKGROUND OF THE INVENTION

A prior art process for creating and delivering personalized mailings requires a user: (a) to compile an address list of target recipients that will receive the communications—the list is sent to a third party address verification system for the addresses to be verified and properly formatted; (b) to design a document template using an application such as Microsoft Word or the like; and (c) to “mail-merge” the address list and the document template to produce a large print file containing individualized copies of the document template with information from the address list. This process typically requires many manual steps in which the user selects a mapping from data fields within the address list to placeholder fields in the document template—iterations and trial and error attempts are common during this phase of the process. Upon completion of the mail-merge, the merged documents are typically aggregated into a large print file, or a collection of print files, that is sent to a single commercial print provider. The commercial print provider then performs an impositioning step on the print files to size the documents to fit onto paper to be used for printing. When the impositioning step is completed, an impositioned file is sent to a printer where images of the documents are transferred to a print medium to become mail pieces. After printing and finishing the mail pieces (finishing refers to steps such as, for example and without limitation, cutting and inserting), the final mail pieces are sent to a print sortation facility for sorting according to various predetermined criteria to obtain discounts in postal fees. For example, the mail pieces may be sorted into separate trays in a particular order based on delivery address.

As one can readily appreciate from the description above, the process for creating and delivering personalized mailings on a large-scale is tedious, error-prone, time-consuming, and labor intensive. Furthermore, current methods for printing cannot produce complex, data-driven mailing documents that are tailored to their recipients based on any number of predetermined criteria relating to the recipients.

As one can readily appreciate from the above, a need exists in the art for method and apparatus to overcome one or more of the above-identified problems.

### SUMMARY OF THE INVENTION

One or more embodiments of the present invention solve one or more of the above-identified problems. In particular, one embodiment of the present invention is a method for managing a message campaign that comprises: (a) creating one or more messages to be sent to one or more members of a target audience for the message campaign, wherein the one or more messages comprise address information to be used to provide a response; (b) collecting response information pertaining to one or more members of the target audience that respond to a received message; and (c) associating the response information with the responsive members.

### BRIEF DESCRIPTION OF THE FIGURE

FIG. 1 shows a block diagram of a system that is fabricated in accordance with one or more embodiments of the present invention, which system generates communications in a distributed fashion and presents a web-browser based interface to users;

FIG. 2 shows a block diagram of components of the system shown in FIG. 1 that are used to support web site interaction for capturing audience responses;

FIG. 3 shows a flow diagram of an Order process that enables a client to generate an Order for a message campaign, which Order process is fabricated in accordance with one or more embodiments of the present invention;

FIG. 4 shows a flow diagram of a Production process that takes a Submitted Order for a message campaign to mailing, which Production process is fabricated in accordance with one or more embodiments of the present invention;

FIG. 5 shows a block diagram of a Rendering process that generates individual messages in a message campaign, which Rendering process is fabricated in accordance with one or more embodiments of the present invention;

FIG. 6 shows a block diagram that helps illustrate how Merged Jobs shown in FIG. 4 are provided in accordance with one or more embodiments of the present invention;

FIG. 7 illustrates an impositioning process that is fabricated in accordance with one or more embodiments of the present invention.

### DETAILED DESCRIPTION

One or more embodiments of the present invention pertain to method and apparatus for refining messages sent to a target audience in a message campaign (for example and without limitation, a mail campaign and/or an electronic campaign) based on responses received from one or more subsets of the target audience. In accordance with one or more such embodiments, a subset may include an individual audience member or the entire group. As will be described in detail below, one or more such embodiments of the present invention are useful in, for example and without limitation, general commerce, targeted marketing campaigns, advertising, education, news delivery, product recall notifications, application and submission tracking, public safety announcements, and the like.

Advantageously, use of one or more embodiments of the present invention increase the efficiency of advertising campaigns. For example, in accordance with one or more such embodiments, materials are sent out in a message campaign, audience members (i.e., message recipients) respond, information is collected from such responses, and the collected information is used to generate additional or follow-up message campaigns.

In accordance with one or more embodiments of the present invention, a web-browser based interface is presented to users (also referred to herein as clients), so that a user using a web browser can communicate with a system over a network, typically the Internet or a company intranet, through a firewall. In response, the system presents data to the client, and collects responses from the client to create a message campaign. The back and forth exchange of information between the client and the system enables great flexibility in creating the message campaign by determining, for example and without limitation: (a) types and formats of messages, (b) audiences, and (c) actions desired during the message campaign. After creating the message campaign, the system performs tasks such as, for example and without limitation, audience list management, cost optimization, address verification, and collection of responses from audience members of the message campaign (i.e. message recipients). In accordance with one or more embodiments of the present invention, messages may take the form of, for example and without limitation, electronic communications, printed materials, or a combination of electronic communications and printed materials such as, for example and without limitation, printed material referring to a web site or other electronic communication. In accordance with one or more embodiments of the present invention, the system can create message campaigns comprised of messages having unique web addresses, or identifying tags, that enable audience members (i.e., message recipients) to visit customized web pages. Then, in accordance with one or more embodiments of the present invention, whenever an audience member (i.e., message recipient) visits a uniquely identified web site, he/she is presented with material unique to himself/herself, which unique material is based on information stored by the system or utilized by the system—this information is usually stored in the form of logical lists. As will be described further below, these logical lists are typically stored in a database as rows in a table. However, the data can also be dynamically retrieved from other external systems via a database link interface such as, for example and without limitation, Open DataBase Connectivity (“ODBC”). In accordance with one or more embodiments of the present invention, the system builds the customized web pages dynamically; based on a personalized URL (“Uniform Resource Locator”) used.

Generating a Message Campaign:

In accordance with one or more embodiments of the present invention, a message campaign is created by creating messages and sending them to members of an audience. An audience member is an entity that receives a message. For example, and without limitation, an audience member may include an individual, a household, a business, a position in a organization, or any one or thing that receives a message such as, for example and without limitation, computer that processes messages. In accordance with one or more embodiments of the present invention, a message campaign may be a single “mailing” or communication sent to an audience, or it may also includes one or more follow-up mailings or communications that may or may not depend on responses audience members have made to previous message campaigns.

In accordance with one or more embodiments of the present invention, a message may be, for example and without limitation, one or more of the following: an offer, a promotion, a mailing, a coupon, or any other solicitation in the form of printed material (such as, for example and without limitation: (a) a written document, (b) a written document containing a reference to a web site. (c) a postcard, or (d) a brochure) or an electronic communication (such as, for example and without limitation: (a) an e-mail, (b) an e-mail containing a reference to a web-site, (c) an SMS (“Short Message Service”) message, or (d) a facsimile transmission). In particular, messages might typically contain pictures, text, and graphics that may be combined or rendered from various sources prior to or after delivery of one or more portions of the message.

In accordance with one or more embodiments of the present invention, a system is connected to a network (where a network is used in the broadest sense to refer to a means for communicating between computers such as, for example and without limitation, an intranet, the Internet, a WAN (“Wide Area Network”), a LAN (“Local Area Network”), a wireless network, and so forth), and a client operating a terminal (where a terminal is used in the broadest sense to refer to a means for a human to communicate with a network such as, for example and without limitation, a personal computer) at a location anywhere in the world connects to the system using, for example and without limitation, a web browser. Information is exchanged using a system to web browser interface to determine specifications of a desired message campaign. When the exchange of information is complete, the system utilizes the information collected to generate a message campaign with specification selected by the client. Further, in accordance with one or more embodiments, audience members (i.e., message recipients) may provide responses to the messages, which are captured by the system. The system makes the responses available to the client for use in tailoring follow-up message campaigns.

FIG. I shows a block diagram of System 1000 that is fabricated in accordance with one or more embodiments of the present invention. In accordance with one or more embodiments of the present invention, System 1000 generates communications in a distributed fashion (using one or more of a plurality of Service Processors 1401-140j), and presents a web browser interface to clients in the manner described below. As will be explained below, System 1000 interfaces with a client and an Administrator by hosting HTML (Hypertext Markup Language) web page interactions as a series of web pages over a network such as, for example and without limitation, a company intranet or the Internet. Advantageously, this enables central administration and management of System 1000, while System 1000 can be used by a client base located anywhere a connection, for example and without limitation, an Internet connection, exists. In accordance with one or more embodiments of the present invention, a single server can support multiple installations of System 1000 wherein an installation may be defined as an independent database and its associated web interface and wherein each installation has its own URL in accordance with any one of a number of methods that are well known to those of ordinary skill in the art. As a result, the web interface of each installation can be independently customized or branded with logos and color schemes, if desired.

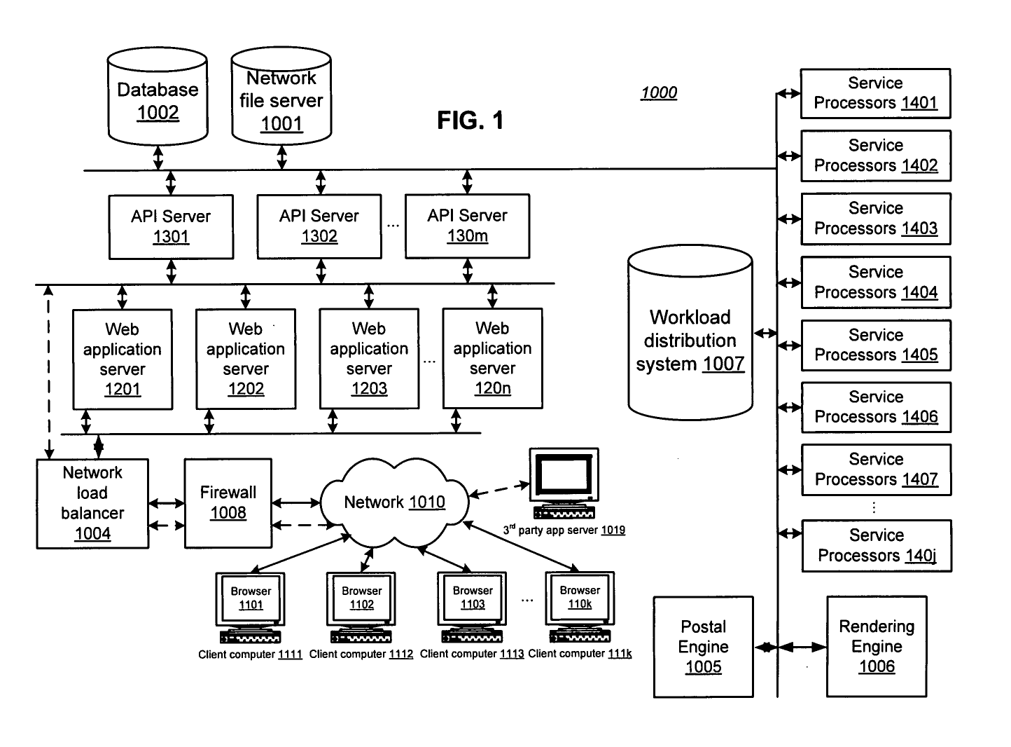

As shown in FIG. 1, System 1000 comprises a network of computers that communicate over a system-network (i.e., a network “internal” to System 1000) wherein information is shared among the networked computers in accordance with any one a number of methods that are well known to those of ordinary skill in the art. In accordance with one or more such embodiments, all components of System 1000 shown in FIG. I are present, online, and available for use; however, many functions carried out by System 1000 are implemented using subsets thereof As a result, not all the components shown in FIG. 1 need be present to carry out one or more of the processes described below. In addition, the system-network may be embodied using separate network segments for one or more of the components shown in FIG. 1 to provide improved performance and security. An advantage of using separate network segments for the system network is that network traffic between unrelated servers does not need to contend for the same network pipe, and as a result, performance may be improved. A further advantage of using separate network segments relates to security. In particular, System 1000 will be less exposed when using a segmented network because, if a machine is compromised, only a limited amount of network traffic will be exposed to the compromised machine.

In accordance with one or more embodiments of the present invention, in order to facilitate development of components and distribution of workload within System 1000, a common service architecture is used throughout System 1000. In addition, and in accordance with one or more such embodiments, in order to be highly scalable and robust, System 1000 is designed so there is no central server that co-ordinates the workload.

As shown in FIG. 1, clients use Web Browsers 1101-110k running on Client Computer Systems 1111-111k, respectively, to communicate over Network 1010 (for example and without limitation, the Internet) with System 1000. In accordance with one or more embodiments of the present invention, Firewall 1008 shown in FIG. 1 restricts access to a specified list of ports and machines in accordance with any one of a number of computer security methods that are well known to those of ordinary skill in the art. Specifically, Firewall 1008 takes, as input, data requests and input received over Network 1010, and produces, as output, data requests and input to Network Load Balancer 1004. In accordance with one or more embodiments of the present invention, Firewall 1008 may be implemented as a software program or as a dedicated apparatus such as the Cisco® Pix Firewall available from Cisco Systems, Inc. of San Jose, Calif.

Network Load Balancer 1004 shown in FIG. 1 receives, as input, data requests and input from Firewall 1008, and produces, as output, data requests and input (in a distributed manner) to: (a) Web Application Servers 1201-120n (Web Application Servers 1201-120n service data requests and input) for interactions with clients utilizing Web Browsers 1101-110k on Client Computer Systems 1111-111k, respectively; and (b) API (“Application Programming Interface”) Servers 1301-130m for interaction with clients utilizing third party Applications Servers such as Third Party Application Server 1019. In accordance with one or more embodiments of the present invention, Network Load Balancer 1004 assigns computing resources according to administrator-developed criteria to balance utilization and response time of requests that may be serviced by Web Application Servers 1201-120n or API Servers 1301-130m using any one of a number of methods that are well known to those of ordinary skill in the art.

In accordance with one or more embodiments of the present invention, Web Application Servers 1201-120n shown in FIG. 1 accept, as input, requests for information and input from Web Browsers 1101-110k, and produce, as output, information in a format usable by a web browser. Such output information is delivered to Web Browsers 1101-110k (through Network Load Balancer 1004 and Firewall 1008) to update information displayed thereby as work is processed. In addition, and in accordance with one or more embodiments of the present invention, Web Application Servers 1201-120n format requests for information retrieval from Database 1002, for example and without limitation, in XML (“Extensible Markup Language”), and transmit such requests, as output, to API Servers 1301-130m. In further addition, Web Application Servers 1201-120n accept information retrieved from Database 1002, as input, from API Servers 1301-130m, for example and without limitation, in an XML format. In still further addition, Web Application Servers 1201-120n store information and files related to web pages including, for example and without limitation, HTML files, configuration files, page display order information, and so forth in Database 1002 and Network File Server 1001 by transmitting such information, as output, to API Servers 1301-130m.

For sake of understanding the operation of System 1000, consider the following example. A client using Web Browser 1105 operating on Client Computer System 1115 initiates a URL data request. Next, Web Application Server 1202 receives the request, and in response, Web Application Server 1202 prepares a data request to retrieve data from, or to store data in, Database 1002. Next, Web Application Server 1202 communicates with API Server 1304, and in response, API Server 1304 communicates with Database 1002. In accordance with one or more embodiments of the present invention, communication between Web Application Server 1202 and API Server 1304 uses an open standard communication protocol, such as SOAP (“Simple Object Access Protocol”), although it is possible to use any one of a number of other communication protocols that are well known to those of ordinary skill in the art such as, for example and without limitation, RPC (“Remote Procedure Calls”) over HTTP (“Hypertext Transfer Protocol”), DCOM (“Document Object Model”), and so forth. Information for a client data request may include, for example and without limitation: (a) an action the client is requesting; (b) a field name the client wishes to retrieve or store; (c) a type of data to be stored (such as, for example and without limitation, integer or string); and (d) a textual representation of a data value (when the client is requesting to store data). In accordance with one or more embodiments of the present invention, Web Application Server 1202 includes various layered components for handling a client data request and for formatting such requests to Database 1002 using any one of a number of methods that are well known to those of ordinary skill in the art.

In accordance with one or more embodiments of the present invention, API Servers 1301-130m shown in FIG. 1 are substantially the same in terms of functionality, and they process data requests and input received, as input, from: (a) Web Application Servers 1201-120n; or (b) Application Servers such as Third Party Application Server 1019. In response to the requests and input, API Servers 1301-130m generate, as output, commands to store and/or retrieve data from Database 1002 and/or Network File Server 1001. In accordance with one or more embodiments of the present invention, API Servers 1301-130m determine which of several methods can be used to handle the data request, depending on the format and implementation of Database 1002. In accordance with one or more embodiments, formatted requests are implemented as method calls to a class name. To do this, a method name is determined by combining an action being requested (such as “get” or “set”) with a data area name (such as “StreetAddress”). Then, the combined name, such as “getStreetAddress”, is used to query a Java class to locate a correspondingly named Java method. The identified Java method is then used to perform the data request, for example, by obtaining a street address from Database 1002. In accordance with one or more further embodiments, formatted requests are implemented as database queries that are communicated directly to Database 1002.

In accordance with one or more embodiments of the present invention, when data is retrieved from Database 1002, API Servers 1301-130m format the retrieved data into a format suitable for use by Web Application Servers 1201-120n. Then, in turn, Web Application Servers 1201-120n convert the retrieved data into a format suitable for display by Web Browsers I01-10k—this format is typically in the form of a textual string that can be utilized by multiple client web browsers.

In accordance with one or more embodiments of the present invention, the data retrieved by Web Application Servers 1201-120n are collected and used to build a single document, typically an HTML document, which includes retrieved and converted data. The document containing possibly updated or modified data is then sent via Network 1010 to Web Browsers 1101-110k executing on Client Computer Systems 1111-111k. For example, upon receipt of HTML documents, Web Browsers 1101-110k interpret and display the data to clients.

In accordance with one or more embodiments of the present invention, clients may write their own applications that directly access API Servers 1301-130m using third party Application Servers such as, Third Party Application Server 1019 shown in FIG. 1. Additionally, clients may directly access API Servers 1301-1303 from software applications running on Client Computer Systems 1111-111k. Advantageously, such direct access enables clients: (a) to have greater flexibility in building an API or a graphical display; and (b) to directly access functionality provided by API Servers 1301-1303 without translation through HTML syntax. In accordance with one or more embodiments of the present invention, during such direct access, Network Load Balancer 1004 passes communications from Third Party Application Server 1019 directly to API Servers 1301-130m—thereby bypassing Web Application Servers 1201-120n.

As an example to help understand one or more embodiments of the present invention, assume that Client Computer System 1111 shown in FIG. 1 receives an HTML document from System 1000 over Network 1010. In response, Web Browser 1101 reads the HTML document, and displays the formatted document to the client via a display system of Client Computer System 1111. For example and without limitation, in a Windows-oriented display system, Web Browser 1101 would be a window that is visible on a physical display device of Client Computer System 1111. Although the functioning of one or more embodiments of the present invention have been described with reference to the use of HTML documents, it should be understood by those of ordinary skill in the art that further embodiments of the present invention are not thusly limited. In particular, it is contemplated that documents formatted in accordance with other standards or languages, or even a raw stream of data, can be used in conjunction with software running on Client Computer System 1111 to display information.

In accordance with one or more embodiments of the present invention, Database 1002 shown in FIG. 1 accepts, as input, information from the system-network, and produces, as output, information from data it stores. Database 1002 stores data so that it can be retrieved through database queries. There are many methods that are well known to those of ordinary skill in the art for implementing Database 1002. For example and without limitation, Database 1002 may comprise a relational database running on a computer. There are many commercially available relational databases that are suitable for such purposes such as, for example and without limitation, an SQL (Structured Query Language) Server available from Microsoft Corporation of Redmond, Wash.; mySQL open source relational database software available in the public domain from http://dev.mysql.com; and relational databases available from Oracle Corporation of Redwood Shores, Calif.

In accordance with one or more embodiments of the present invention, Network File Server 1001 shown in FIG. 1 is a database system that stores images and document files that are so large that storing them on Database 1002 might slow down operation of System 1000. In accordance with one or more embodiments of the present invention, functions performed by Network File Server 1001 and Database 1002 may be combined on a single computer system or they may be a run on a collection of computer systems. In addition, it should be understood by those of ordinary skill in the art that further embodiments of the present invention exist wherein Database 1002 and Network File Server 1001 are combined into a single database system.

In accordance with one or more embodiments of the present invention, Server Processors 1401-140j shown in FIG. 1 are comprised of computing resources available for performing specific tasks (such tasks to be carried out by System 1000 are referred to herein as service tasks, and as will be described in detail below, Work Distribution System 1007 manages the work flow of service tasks involving Server Processors 1401-140j). In accordance with one or more embodiments of the present invention, Server Processors 1401-140j (j may vary from

1 to a larger number) are typically computers clustered on the system-network that are capable of receiving and performing the service tasks. Further, in accordance with one or more such embodiments, Server Processors 1401-140j may be lower-end (i.e., inexpensive, but perhaps, less reliable) computers, and each of Server Processors 1401-140j will be configured so that it can carry out one or more of the required service tasks. Typically, and in accordance with one or more such embodiments, Server Processors 1401-140j are used whenever the time to process a particular service task is relatively long, and an instantaneous response is impractical. Further, in accordance with one or more embodiments of the present invention, the service tasks each of Server Processors 1401-140j is configured to perform is based on its computer capabilities and its software configuration.

To understand this aspect of one or more embodiments of the present invention, assume that a set of service tasks include, for example and without limitation, production/ip and addressload. Further assume that the production/ip service task (a service task to cause a Job to be rendered into a printer format file) requires a computer having a fast CPU, whereas the addressload service task requires a computer having fast disk I/O. As one can readily appreciate from this, these requirements will dictate the choice of service tasks assigned to the computers. In addition, if a service task required use of third party software components that incurred licensing fees, to reduce such fees, only some of Server Processors 1401-140j might be configured to process such a service task.

In accordance with one or more embodiments of the present invention, whenever one of Server Processors 1401-140j is started, it will periodically register its availability with a database in Database 1002. Specifically, that one of Server Processors 1401-140j will: (a) update the database with its machine name, the service tasks it can perform, and when it last registered its availability; and (b) create a queue for each of the service tasks it can perform. In accordance with one or more embodiments of the present invention, the queue is a queue in a messaging system such as, for example and without limitation, Microsoft® Message Queue (MSMQ) that is available from Microsoft Corporation of Redmond, Wash., or MQSeries (an IBM software family whose components are used to tie together other software applications) that is available from International Business Machines Corporation of Armonk, N.Y.

In accordance with one or more embodiments of the present invention, Rendering Engine 1006 (i.e., an internal and/or external means for creating electronic art work, electronic messages, or postal mailings) shown in FIG. 1 receives, as input, job requests from Workload Distribution System 1007 shown in FIG. 1, and optionally information from Database 1002 and Network Fileserver 1001, via the system-network. In response to the Job requests, Rendering Engine 1006 executes one of several programs, typically commercially available programs, for rendering documents such as, for example and without limitation, Adobe® Indesign® Server page layout software available from Adobe Systems Incorporated of San Jose, Calif.; or Quark® Dynamic Document Server (QuarkDDS®) available from Quark, Inc. of Denver Colo. The rendering step typically comprises combining images, text, and other graphics to create a piece of artwork that forms a Document Template. The Document Template is then optionally stored in Database 1002 or Network Fileserver 1001, or it is used immediately. In accordance with one or more embodiments of the present invention, the Document Template is combined with an individual address in an address Data List obtained from Database 1002 to create a message that is directed to a particular audience member, for example and without limitation, a particular member's name and address are incorporated into the artwork. Then, after the name, address, and the art work are combined, an output is generated in an image format that may be sent to printers in print shops for fulfillment. For example and without limitation, the image format may be a series of customized PDF print files, or formats such as Postscript®, VIPP™ (an open language from Xerox), PPML (Personalized Print Markup Language), and VPS (VTAM Printer Support). These image formats are usually a combination of raster images and vector commands, as well as, formatted text. In addition, formats such as VIPP and VPS have additional features to cache elements that are reusable, so that the overall image file sent to the printer may be made smaller. In accordance with one or more embodiments of the present invention, while generating the image formats, Rendering Engine 1006 keeps track of the images being used so that it generates the proper commands in the output file format to cache and reuse those elements whenever possible. As one can readily appreciate from the above, this step enables customized and personalized mailing documents to be created: (a) using industry standard software packages to create a Document Template; and (b) using that Document Template, along with data from Database 1002.

It should be understood that in accordance with one or more embodiments of the present invention, further embodiments of Rendering Engine 1006 might include any one of a number of further techniques to create a customized and personalized message for a particular audience member. For example and without limitation, and in accordance with such one or more embodiments, such further techniques may include, for example and without limitation, changing one or more of a color, textual information, or combinations of both, in a particular piece of artwork according to information about a particular audience member that is stored in Database 1002. For example and without limitation, aspects of message text may be altered if a particular audience member has responded to previously sent messages, for example and without limitation, within a particular time frame. As a further example, the overall color of a Document Template artwork may be changed according to a geographical location of the particular audience member such as, for example and without limitation, red or brown for residents of Arizona, and green for residents of Florida.

In accordance with one or more embodiments of the present invention, Postal Engine 1005 (i.e., an internal and/or external means for mass-mailing materials electronically or via postal services) shown in FIG. 1 receives, as input, Job requests from Workload Distribution System 1007, and data representing addresses from Database 1002. In response, Postal Engine 1005 produces, as output, data representing addresses. In accordance with one or more embodiments of the present invention, Postal Engine 1005 performs three processing steps. The first processing step (a step of verifying addresses) comprises checking names and addresses received as input against United States Postal Service (“USPS”) records to verify that the addresses are in a standardized format. If errors are detected during this first processing step, an indication of the error is generated and provided as output, i.e., this information is updated back into the list, and the client can browse through the list to see the addresses and correct them as necessary. During this first processing step, if an address is found to be noncompliant in a minor way, Postal Engine in 1005 will alter the data to make it compliant. The address correction is performed using postal software such as, for example and without limitation, Satori software available from Satori Software, Inc. of Seattle, Wash., or Postalsoft software available from FirstLogic, Inc. of San Jose, Calif. These software packages are certified by the USPS or other postal agencies for other countries to format addresses properly. In the case of an error, these software packages use a set of heuristics to correct the error. These heuristics are usually based on typos or improper address formatting—heuristics vary from software to software, and the quality thereof is a factor distinguishing a top end software package from an entry-level, inexpensive one. System 1000 is designed so that it can be integrated with any postal software package. The second processing step (a step of performing sortation) comprises a reorganizing step wherein addresses are rearranged in accordance with a specific presorted order required by the USPS for tray sorting, or in accordance with other arrangements, tray sortation is performed by third party software that is certified by the USPS or other postal agencies for other countries such as Satori software or Postalsoft—sortation of mail pieces is based on constantly changing rules imposed by postal agencies. The purpose of sortation is to improve the efficiency of the postal agencies by having mail pieces arranged in an order optimized for a post office to route to different post offices or mail carriers. In exchange for performing sortation, postal agencies typically offer a discount on the cost of sending mail. The third processing step comprises an address updating step. The third processing step is performed before the actual mailing of a document, or the generation of an envelope. In performing the third processing step, Postal Engine 1005 compares each name and address in an input list of audience members against a USPS “move-update” database. Move-update is performed by third party software that is commercially available. Due to the confidentiality of the data involved, the move-update process is usually offered as a web service or through black box hardware whose data is updated frequently. Any address for which there is a change of address in effect with the USPS is automatically updated back into Database 1002. It should be understood that Postal Engine 1005 might process single addresses or a list of addresses as required. Furthermore, it should be understood that although Postal Engine 1005 has been shown in FIG. 1 as a single component, in accordance with one or more further embodiments of the present invention, Postal Engine 1005 might comprise various software programs running in disparate locations and sharing data over a network or other means.

In accordance with one or more embodiments of the present invention, Workload Distribution System 1007 shown in FIG. 1 comprises a collection of software running on one or more computers. Workload Distribution System 1007 forms a part of a sub-system of System 1000 that includes computing resources such as Service Processors 1401-140j; Postal Engine 1005; and Rendering Engine 1006. The parts of the sub-system communicate with Database 1002, Network File Server 1001, and with Workload Distribution System 1007 over the system-network of System 1000. In accordance with one or more embodiments of the present invention, two types of software make up the collection of software of Workload Distribution System 1007: (a) Task Queuing Software (comprised for example of a software library); and (b) Task Servicing Software (comprised for example of a software library). In accordance with one or more such embodiments, a plurality of service tasks are queued in a Task Queue that is stored in Database 1002, and a plurality of computing resources execute service tasks from the Task Queue. This sub-system has several benefits: (a) service tasks are serviced immediately whenever a computer with the required computing resources becomes available; (b) the fastest machine to respond is usually the least heavily loaded with service tasks, and gets the service task first; (c) service tasks are serviced as fast as possible; (d) the sub-system is fault tolerant in that, in the event of failure of one machine, a service tasks can continue to be serviced by other machines with similar computing resources that are up and running.

Whenever a service task needs to be performed by System 1000 (either one that is initiated by a client or one that is initiated by System 1000 itself), Workload Distribution System 1007 creates an entry in the Task Queue for that service task. Periodically, Workload Distribution System 1007 accesses the Task Queue to determine the service tasks that need to be performed, and accesses Database 1002 to obtain information relating to the availability of the various computing resources (for example, a list of Service Processors 1401-140j that have registered recently and that can process particular service tasks). For example and without limitation, such service tasks may include creating customized artwork, letters, electronic mailings that contain recipient-specific data (for example and without limitation, name, address, and the like), submitting an order, processing an address list, and publishing a web campaign. In response, Workload Distribution System 1007 will then send a message containing information about a service task to a queue for each of the appropriate available computing resources.

In accordance with one or more embodiments of the present invention, Service Processors 1401-140j are constantly waiting on each of their queues for a new message. Whenever a message is received, a Service Processor it will check the Task Queue to make sure that the particular service task has not already been performed by another of Service Processors 1401-140j. If the service task has been performed already, the Service Processor will discard the message, and return to monitoring the queue for another message. On the other hand, if the service task has not been performed, the Service Processor will update the Task Queue to indicate that it has “grabbed” the service task. The Service Processor will then perform the service task associated with that message. When the Service Processor is done with the service task, it goes back to monitor the queue for another message, or it processes the next message immediately if one was already waiting. In accordance with one or more embodiments of the present invention, a message is sent to all Service Processors that can process a service task. Thus, if any one of Service Processors 1401-140j is busy, another one of Service Processors 1401-140j will pick up the service task. In addition, in accordance with one or more embodiments of the present invention, since the message is sent to all Service Processors that can process the service task, the first Service Processor that is free to perform the service task will grab it.

In accordance with one or more embodiments of the present invention, the Task Queue is a database stored in Database 1002 that is used as a clearinghouse for service task information. In accordance with one or more such embodiments, the Task Queuing Software accepts, as input, a service task (identified by a pre-defined code). In response, and in accordance with one or more embodiments of the present invention, the Task Queuing Software: (a) identifies computing resources required to perform the particular service task; and (b) produces an information structure containing the pre-defined code, location information for input and output files, and optionally, information regarding the computing resource requirements for processing the service task. Then, using the system-network, the Task Queuing Software transmits the information structure to the Task Queue in Database 1002 for storage therein,

In accordance with one or more embodiments of the present invention, the Task Servicing Software periodically accesses the Task Queue, and, optionally, checks computing resource requirements with those available. For example, if computing resources on a currently running machine are sufficient to fulfill the computing resource requirements of a service task, the Task Servicing Software marks the status field of the service task in Task Queue 8002 as “in progress,” and transmits the service task to a queue for processors meeting the computing resource requirements. If there is no match for required computing resources, the Task Servicing Software examines the next service task in the Task Queue. Once a service task begins executing, information regarding the input file location and output file location is extracted from the service task information, and upon completion, the service task is removed from the Task Queue.

In accordance with one or more embodiments of the present invention, the Task Queuing Software and the Task Servicing Software might both run simultaneously on a single computer so that a computer completing a job may also submit a service task for further processing as that job completes.

Although FIG. 1 depicts various components of System 1000 as being separate, it should be understood that each of the components may be implemented on separate computers or devices, or as a software module on one or more computers which may execute a plurality of other software that implement other components.

Client Order Processing

As previously described, producing a message campaign comprises creating and sending one or more messages to members of an audience (where the audience is typically specified in the form of a mailing list). In a first step of producing a message campaign, a client creates a new Document (sometimes referred to herein as a Document Template) or modifies an existing Document using a client web interface. The resulting Document may contain: (a) artwork, images, and/or text that is common to all message recipients; and/or (b) placeholders for artwork, images, and/or text for specific messages which are derived using formulas or rules that are to be evaluated in light of information specific to each audience member; and/or (c) placeholders for information specific to each audience member. In a second step of producing a message campaign, a client provides a list of audience members. In a third step of producing a message campaign, the client s specifies message delivery options, previews the results of merging the Document and audience list data, and submits an Order. Later in a Production phase of producing a message campaign, the Document and information that uniquely identifies particular audience members from a Data List are merged or instantiated on the Document Template to create unique messages. As a result, each message sent to an audience member is created from a combination of: (a) a Document; (b) a list of audience members (Data List); and, optionally, (c) data specific to each audience member.

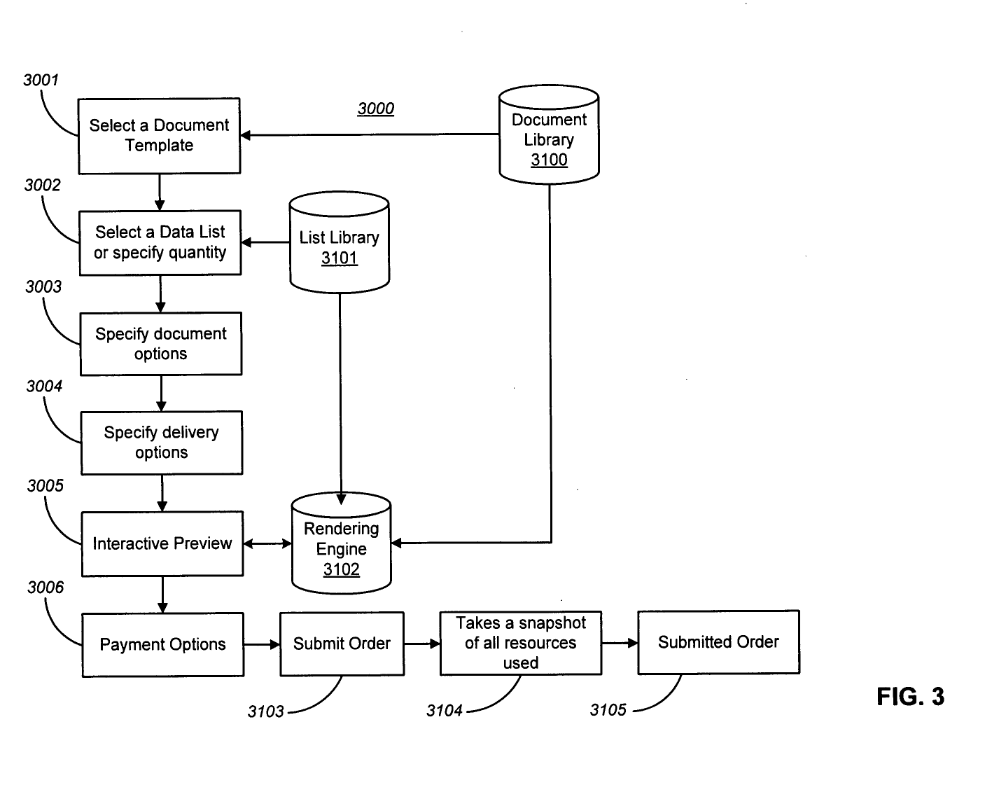

FIG. 3 shows a flow diagram of Order process 3000 (that is fabricated in accordance with one or more embodiments of the present invention), which Order process 3000 enables a client to generate Submitted Order 3105 for a message campaign. In accordance with one or more embodiments of the present invention, these steps are performed: (a) by the client using a web based interface provided by one of Web Browsers 1101-110k running on Client Computer Systems 1111-111k; and (b) by System 1000 using Web Application Servers 1201-120n (as described above, information required from Database 1002 and/or Network File Server 1001 is obtained using API Servers 1301-130m as an intermediary). Whenever the client submits an Order, one of Web Application Servers 1201-120n calls one of API Servers 1301-130m to submit the order. That one of API Servers 1301-130m, in turn, after validating the Order as being proper, issues a jobsubmit service task for the Order to be submitted.

In accordance with one or more such embodiments, the client's web browser displays pages with various menus that the client may select or into which the client may enter data. It should be understood that embodiments of the present invention are not limited to such interfaces as there are other methods that are well known to those of ordinary skill in the art that may be used to present choices to a client and to receive input indicating selections made by the client.

As a web application, the capabilities of System 1000 are delivered to the client as a series of web pages over a company intranet or via the Internet. In addition to unique content displayed by each web page, each page may also contain, for example and without limitation, near the top each web page, a horizontal bar containing drop-down menus, links, and other items, all as would be provided in accordance with any one of a number of methods that are well known to those of ordinary skill in the art. For example, the menu bar may contain: (a) an Orders Menu with a link to view previous Orders; (b) an Assets Menu (Assets include, for example, Documents, Layouts, and Images) with links to Documents, Layouts (where Layouts contain many of the same elements as Documents, and can be used to standardize formats of text that will be used in many different Documents, like boilerplate legal text), Images (where an Image is often a picture file that is uploaded by the client, but may also refer to any object that is uploaded and used “as is”), and optionally, Web Sites; (c) a Data Menu with links to Data Lists (a Data List is a list of information, typically a list of customer contact information, stored in System 1000) and to Data Templates (for example, when a list file is uploaded to System 1000 to create a new Data List, each of the columns in the list file is mapped to a column in a Data Template—by using the names of columns in a Data Template, the content of these columns in the Data List can be inserted into a Document where the Document serves as a template with variable and static elements (static text, variable text, static images, variable images, variable pages, and other elements). As will be described below, Documents are processed to create information that is sent to one or more physical Production Centers where pieces are printed and then mailed.); and (d) an Action Menu appropriate to a particular web page. All of the above-described Menus may be provided using any one of a number of methods that are well known to those of ordinary skill in the art.

In accordance with one or more embodiments of the present invention, an Administrator creates Product Types and other Resources for an installation. A Product Type defines: (a) physical attributes of a Document such as, for example and without limitation, size and a maximum number of pages; and (b) Resources that are available for production of the Document such as, for example, and without limitation, Envelopes, Paper Type, Print Type, Fonts (to use a font, a font file must be uploaded to create a Font Resource—Font Resources are created by an Administrator), Colors (to use a color, the color must first be defined by having an Administrator create a new Color Resource), Inventory Items, and so forth -all of which are configured by an Administrator.

In accordance with one or more embodiments of the present invention, most Resources depend on other Resources. For example, each Paper Type requires one or more Print Types because some types of paper only work with certain types of ink. Resources with the fewest or no dependencies are usually created first, followed by Resources with greater dependencies. After Resource creation, the Administrator defines Pricing for Resources that require Pricing. For example, Resources that require Pricing are: (a) Print Types; (b) Paper Types; (c) Envelopes; (d) Mail Classes (a Mail Class is a level of service defined by the USPS that is used to mail all pieces of a Print Job, usually each to a separate address); (e) Product Types; and (f) Inventory Items. Resources that do not require Pricing include: (a) Address Blocks; (b) Colors; and (c) Fonts. With regard to Product Types, not only does the Product Type require Pricing, but each of the Resources it utilizes (for example, Paper Types, Print Types, Envelopes, and so forth) also have Pricing (at least one Resource of each type used by the Product Type has Pricing). Additionally, a minimum set of Mail Classes utilized by the Product Type also have Pricing defined. Once all Pricing has been defined for all relevant Resources, a client can use these Resources to create Documents.

In accordance with one or more embodiments of the present invention, System 1000 uses a network of Production Centers to manufacture pieces of a Print Job. For each physical Production Center used to manufacture Print Job pieces by System 1000, an Administrator sets up an entity called a ‘Production Center’ within System 1000 in a portion of Database 1002 in accordance with any one of a number of methods that are well known to those of ordinary skill in the art. These Production Centers are administered by a Production Manager, who manages Printers and Inventory for that Production Center. Production Managers are responsible for managing Print Jobs after they have been delivered to the Production Center. In addition, a Production Manager is also responsible for tracking Inventory, where Inventory refers to the quantity of durable Resources (i.e., Paper Types, Envelopes, and Inventory Items) that a Production Center has on site for use in manufacturing the pieces of a Print Job. In accordance with one or more embodiments of the present invention, an Inventory Item is an already-manufactured durable item that can be inserted into each piece of an Order—examples of Inventory Items include, for example and without limitation, key chains, coupons, or other small items. In addition, in accordance with one or more such embodiments, each Production Center includes an entity called a Printer that is defined for each physical printing machine used by that Production Center—where each Printer is configured to support a set of Print Types (a Print Type defines an ink or inks used by a printing machine during printing a piece), Paper Types, and Product Types to enable a client to match the manufacturing capabilities of the physical printer with an Order and to represent the manufacturing capabilities of the physical printer. In accordance with one or more embodiments of the present invention, support and availability of Resources are factors which System 1000 considers when deciding which Production Centers to use to manufacture Orders.

Once one or more Production Centers have been configured within System 1000, these Documents can be used to submit Orders. Typically, an Order uses a Document and a Data List to create a number of customized versions of the Document that, once printed at a Production Center, become the pieces of the Order. In accordance with one or more embodiments of the present invention, an Administrator provides and updates the above-described information using web based menus that may be provided using any one of a number of methods that are well known to those of ordinary skill in the art.

In order to interact with System 1000, a client opens his/her web browser, enters an appropriate URL for access thereto, and enters a User Name and Password, all of which capabilities are provided in accordance with any one of a number of methods that are well known to those of ordinary skill in the art. In addition, System 1000 provides a capability to change a client profile (for example and without limitation, an e-mail address and a password) in accordance with any one of a number of methods that are well known to those of ordinary skill in the art.

In accordance with one or more embodiments of the present invention, Data Lists are created, for example and without limitation, by uploading a list file to System 1000, that may contain names, addresses, demographic data, telephone numbers, e-mail addresses, account numbers, or any other information that a client might want to use in creating messages. In accordance with one or more embodiments of the present invention, and in order to organize a client's Data Lists and to enable a client to create rules that may be used in creating messages, each of a client's Data Lists is associated with a Data Template. In accordance with one or more such embodiments, a Data Template contains information about the client's original list file and address mapping information. In particular, in accordance with one or more such embodiments, each column in a client's uploaded list file is mapped to a column in a selected Data Template. The names of the columns in the selected Data Template are then used as a guide to insert the content of these columns in the Data List into the client's associated Document to create messages. In accordance with one or more such embodiments, Data Templates may contain formulas or rules that specify how information in the client's Data List may be used to generate new values. For example, if the client has a “true/false” column in the client's Data Template called “Gender”, the client can write a formula or rule in a Data Template called, for example, “Pronoun” that causes use of the word ‘him’ in creating a message if the gender is male or the word ‘her’ if the gender is female. In accordance with one or more embodiments of the present invention, a formula is assigned its own column in a Data Template, and the content of a formula column (i.e., the value resulting from executing the formula) can then be inserted into the client's Document using the name of this column. Methods for providing a capability to create, edit, and update Data Templates (including the use of formulas or rules) may be carried out in accordance with any one of a number of methods that are well known to those of ordinary skill in the art.

In accordance with one or more embodiments of the present invention, whenever a client uploads a list file to create a Data List, System 1000 (for example, one of Web Application Servers 1201-120n) will check (for example, Database 1002) to determine if a Data Template exists for the format of the list file. If the columns in the uploaded list file match those of an existing Data Template, the client will have an opportunity to associate the list file, as a new Data List, with that Data Template, or to force the list file into the format of another Data Template. If the client associates the list file as a new Data List with an existing Data Template, the new Data List will automatically inherit any formulas the client has written into that Data Template, as well as the address mapping of that Data Template. In accordance with one or more such embodiments, a Data Template web page lists all Data Templates that are available to the client, and provides links to create new Data Templates, view/edit Data Templates, and perform other Data Template related operations. For example, in accordance with one or more embodiments of the present invention, to perform any of these Data Template related operations, a client may navigate a Data Templates web page, or one may navigate to Data from a Menu Bar, and then select Data Templates from a drop-down menu. Methods for providing any of the above-described capabilities may be carried out in accordance with any one of a number of methods that are well known to those of ordinary skill in the art.

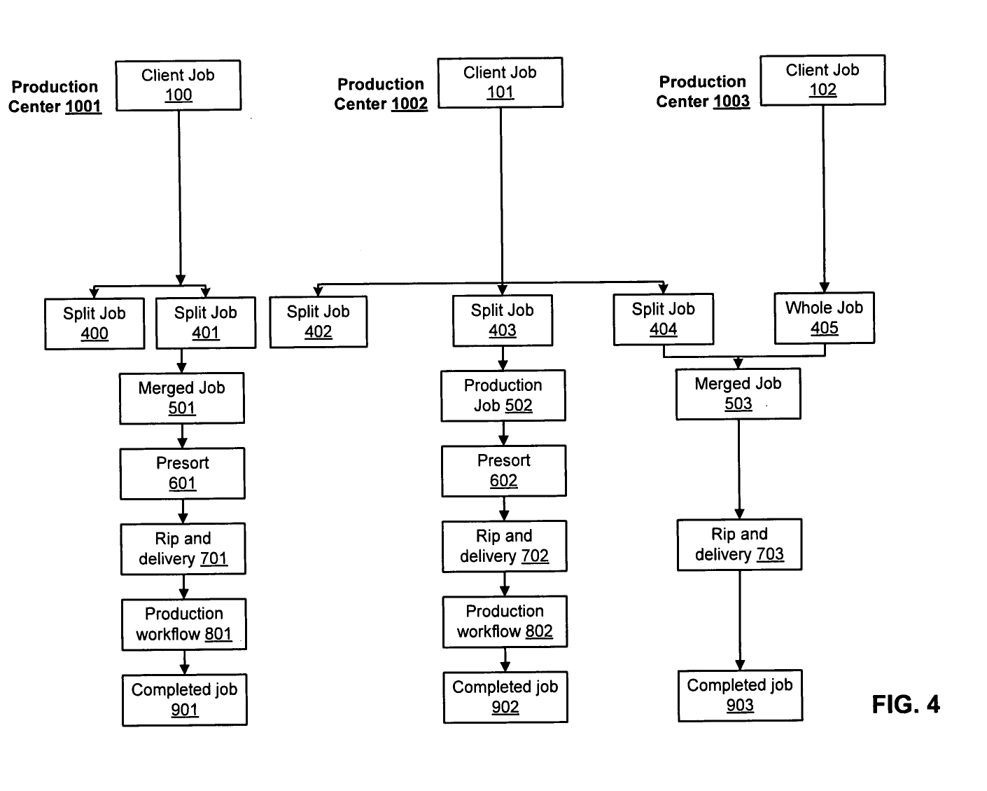

In accordance with one or more embodiments of the present invention, whenever a Document is ready to be sent to a print facility for printing to manufacture messages, the client submits an Order relating to this Document. Typically, a Data List is also utilized in an Order to populate variable fields in the Document. Further, as will be described in detail below in conjunction with FIG. 4, before an Order is manufactured, it may be split into one or more Print Jobs. Further, in accordance with one or more embodiments of the present invention, the Print Jobs are routed to physical Production Centers, i.e., facilities responsible for manufacturing all pieces in a Print Job. Once the pieces are manufactured, the Production Centers pass the pieces to appropriate services for mailing.

As was discussed above, a Document serves as a template (having variable and static elements) which System 1000 processes to create Print Jobs that are sent to one or more Production Centers where pieces in the Print Jobs are printed and then mailed. The Document can contain static text, variable text, static images, variable images, variable pages, and other elements to customize the look and feel of the printed pieces. In accordance with one or more embodiments of the present invention, an Administrator determines what Product Types are available to a particular client. A Product Type is a basic template used to create Documents that contains information about Document format and placement of Address Blocks (an area that is populated with address information from each record in a Data List to create a unique address for each record in the Data List), Document size and number of pages, permissible Paper and Envelope Types, whether other items can be printed with, or inserted into, the finished product, the availability of printing options such as Bleed, and the Colors used. At Step 3001 shown in FIG. 3, a Document page displays all Documents available to a client, and provides links to other web pages to create new Documents, view/edit Documents, and to perform other Document related operations in accordance with any one of a number of methods that are well known to those of ordinary skill in the art. If a client selects a Document Template from a list of Document Templates provided on a web page from Document Library 3100, information conveying that selection is stored locally, i.e., in one of Web Application Servers 1201-120n, or in Database 1002 shown in FIG. 1 for use in building an Order. It should be understood that Document Library 3100, List Library 3101, and Submitted Order 3105 are stored in Database 1002 and/or Network Fileserver 1001 shown in FIG. 1.

In accordance with one or more embodiments of the present invention, the client may create a new Document and/or edit an existing Document. Documents may be designed using one or more of the following: Images and Layouts available from Database 1002, Images, Layouts, and/or Text or even the Document uploaded from the client's computer, artwork generated using any one or a number of methods that are well known to those of ordinary skill in the art.

In accordance with one or more embodiments of the present invention, adding variable text fields or variable image fields to a Document enables the client to customize text contained in the Document from piece to piece during manufacture. In accordance with one or more such embodiments, this is done by associating each variable text field or variable image field with a column in a Data Template assigned to the Document. In turn, the associated column in the Data Template is associated with content in a record in a Data List. An example of this functionality is an Address Block in a Document that is populated with address information from each record in a Data List. In accordance with one or more embodiments of the present invention, Variable Images may be used in Documents when a client wants to use different Images based on data in a Data List—Variable Images may be resized to fit within a space set for them. A Static Image is used in Documents when a client wants the same Image to be used despite changes in the Data List).

In accordance with one or more embodiments of the present invention, a Data Template page displays all of Data Templates available to a client, and provides links to other web pages to create new Data Templates, view/edit Data Templates, and to perform other Data Template related operations in accordance with any one of a number of methods that are well known to those of ordinary skill in the art. A client may retrieve an existing Data Template from Database 1002 for use in assigning it to a selected or created Document (for example, a Data Template page). Further, in accordance with one or more embodiments of the present invention, on a Data Template Columns Page, the client can view all columns in a Data Template, create new columns, delete existing columns, and change the order of column display. In accordance with one or more embodiments of the present invention, a Column List displays all columns in a selected Data Template—information displayed for each column includes: (a) a unique name assigned to the column; (b) a short description of the column; (c) a Data Type of the column; (d) an indicator showing if the column contains a formula or data; (e) an indicator showing if the column is required or not; and (f) a column display order—in accordance with any one of a number of methods that are well known to those of ordinary skill in the art. For example, and without limitation, the following data types are available for Data Template columns: (a) text—text columns contain alpha-numeric data, such as names, descriptions, sentences, or even paragraphs; (b) integer (contains a whole number (1, 2, 101, and so forth)); (c) decimal (contains a floating point number (1.0, 22.3434, 3.14, and so forth)); (d) date (contains a date and time); (e) True/False (contains a Boolean value (True or False)); (f) Image (contains a name of an image that exists in System 1000 that is accessible by the client); (g) Layout (contains the name of a Layout that exists in System 1000 that is accessible by the client); and (h) Data Template (contains another Data Template). In accordance with one or more embodiments of the present invention, there are two choices for Column Type: (a) Data Columns (described above); and (b) Formula columns—a Formula column may contain a formula that generates a value for this column, or expressions to evaluated to provide a data entry. Formulas may utilize values in Data Columns or other Formula Columns. For example and without limitation, a particular formula may indicate that a value in a column be determined using a Zip Code (obtained from an entry in an address field) to determine a population in that Zip Code zone (for example, the population may be determined over the Internet). Then, when the population is determined, a branch on an entry may be made when creating a mailing for a particular audience member. Finally, for Documents that will be sent to a list of different addresses, an Address Column in the Data Template assigned to a Document may specify separate columns for each address attribute (name, street, city, zip, and so forth).

The information specified in this step is stored locally, i.e., in one of Web Application Servers 1201-120n, or in Database 1002 for use in building the Order. Control is then transferred to Step 3002 shown in FIG. 3.

At Step 3002 of FIG. 3, the client selects a Data List from a series of choices of Data Lists presented over a web browser page where the choices come from List Library 3101 (however, in accordance with one or more embodiments of the present invention, instead of using a Data List, the client may specify a predetermined quantity documents where each document is the same). In accordance with one or more embodiments of the present invention, the client can create new Data Lists, or view/edit existing Data Lists. To create a new Data List: the client enters a name for the new Data List—typically, one that identifies the purpose and/or contents of the Data List and makes it easy to recognize. Then, the client may create the new Data List by uploading a list file from the client's local computer, i.e., one of Client Computer Systems 1111-111k, or a storage device attached thereto. In accordance with one or more embodiments of the present invention, System 1000 will accept list files created by Microsoft® Excel®, Access™, and Word that have been saved with :csv, .xls, .mdb, .txt, or .tab file extensions. A preferred format is .csv (comma separated or delimited). This format is stripped of formatting and other artifacts that can cause problems, and these files also upload faster—this can advantageously avoid difficulties when network traffic is heavy. Further, in accordance with one or more such embodiments, the list files may be uploaded using any one of a number of methods for uploading a file over the Internet such as, for example and without limitation, HTTP (REST/SOAP)—REST refers to “Representational State Transfer,” FTP (“file transfer protocol”), or SQL. Advantageously, this provides real-time, automated, transparent data acquisition from various sources external to System 1000 across multiple communications protocols that are parameterized on an ad-hoc basis by the client in a web based communication production workflow.

In accordance with one or more embodiments of the present invention, a client may merge two or more Data Lists that use the same Data Template into a single Data List.

In accordance with one or more embodiments of the present invention, a client may create a new Data List by applying a client-defined filter to an existing Data List in accordance with any one of a number of methods that are well known to those of ordinary skill in the art. For example, such a filter may be a rule that is applied to each record in the existing Data List to create the new Data List. The ability to modify an existing Data List to create a new Data List enables a client to create follow-up message campaigns. For example, assume that a message campaign is created, and a sub-set of the target audience responds—for example, by visiting a web site identified in the message campaign (methods for doing this will be described below). Further assume that information related to these responses (for example and without limitation, information such as time of response, and responses to particular questions) is captured and stored with the existing Data List (methods for doing this will be described below). As such, a client can create filters to extract sub-sets of the target audience depending on any number of criteria, which may be derived based on an analysis of the response information. Further, and in accordance with one or more such embodiments, follow-up message campaigns can be created to be appropriate for one or more such sub-sets.

The information specified in this step is stored locally, i.e., in one of Web Application Servers 1201-120n, or in Database 1002 for use in building the Order. Control is then transferred to Step 3003 shown in FIG. 3.

At Step 3003 of FIG. 3, the client may specify Document options. In accordance with one or more embodiments of the present invention, the following options may be listed on a Document Properties web page, for example and without limitation: (a) Return Address for a Document; (b) Bleed Type where Bleed refers to an area with a background image that will be trimmed off after the Document is printed and cut to the finished size—if Full Bleed is selected, the bleed area configured for the Document's Product Type by the Administrator is used during manufacturing, and if No Bleed is used, then no bleed area is used (i.e., each page of the Document is printed within the finished size for the Document); (c) Print Type where this option indicates the type and selection of inks used to print each page of the Document (such as ‘Color’ or ‘Black and White’) the selection of this option will tell the Production Center what type of printer to use to manufacture the order; (d) Layout Type where Layout type determines if a single side or both sides of each page of your Document will have printing on them; (e) Paper Type where the set of paper types that are available is configured by the Administrator; (f) Envelope Type where the set of envelope types that are available is configured by the Administrator; (g) Document Inserts where Document Inserts are other Documents that are manufactured and then inserted into each piece of an Order—examples of Document Inserts include forms, business cards, coupons, and so forth; and (h) Inventory Inserts where Inventory Inserts are finished items that will be packaged with each piece of the Order—examples of Inventory Inserts include key chains, bottle openers, notepads, and so forth. The information specified in this step is stored locally, i.e., in one of Web Application Servers 1201-120n, or in Database 1002 for use in building the Order. Control is then transferred to Step 3004 shown in FIG. 3.

At Step 3004 of FIG. 3, the client specifies delivery options for messages that will be sent to target audience members. Such delivery options may include, for example and without limitation, one or more of the following: postage rates, electronic or e-mail delivery, presort bulk mail, express Mail, and the like. In addition, the client will select a schedule date for the Order. The information specified in this step is stored locally, i.e., in one of Web Application Servers 1201-120n, or in Database 1002 for use in building the Order. Control is then transferred to Step 3005 shown in FIG. 3.

At Step 3005 of FIG. 3 (an Interactive Preview Step), a final version of the finished message is presented to the client. This final version is generated using output from Rendering Engine 3102, which receives, as input, the Document specified in Step 3001 from Document Library 3100 and the Data List specified in Step 3002 from List Library 3101. In accordance with one or more embodiments of the present invention, this Interactive Preview Step of previewing the final message created from dynamic data selected by the client is implemented using AJAX (Asynchronous Javascript over XML), and which advantageously enables real-time display of changes selected by the client. In accordance with one or more embodiments of the present invention, a preview page is made up of two sections: (a) a customization section where the client can additionally customize by selecting various options, images or by entering text; and (b) a preview section where the preview is shown. By using AJAX, the preview section can be asynchronously updated while the client continues to make changes in the customization section. If this was not implemented using AJAX, the entire web page would have to be reloaded whenever the client made a single customization to see an updated preview that reflects the customization. Alternatively, this function can be implemented using a scripting language in an HTML web page such as JavaScript. In accordance with such an alternative embodiment” (a) a script can asynchronously send data back to a Web Application Server in System 1000; (b) request the Web Application Server to send an updated preview; and (c) then, update the preview in the preview section. Control is then transferred to Step 3006 shown in FIG. 3.

At Step 3006 of FIG. 3, in accordance with one or more embodiments of the present invention, the Web Application Server determines all production and postage costs accumulated for the Order (using Pricing information for the various production and postage costs provided by the Administrator), and presents the results on a web page. In response, the client selects from among several payment methods that are well known to those of ordinary skill and the art for payment collection in an online environment. Such payment methods include, for example and without limitation, accepting credit card numbers, submitting a purchase order, or deducting credit from a prepaid account. Control is then transferred to Step 3103 shown in FIG. 3.

At Step 3103 of FIG. 3, the client submits the Order. Once an Order is submitted, it still may need to be approved before it becomes a Job. If no Approval process has been established for the client by the Administrator, the Order will become a Job automatically. However, if an Approval Workflow is in place, the Order will be analyzed according to processing rules entered into System 1000 by the Administrator. For example, in accordance with one or more embodiments of the present invention, a company Administrator may require: (a) all Orders exceeding a certain dollar amount to be approved by a manager before the Order is submitted for production; or (b) approval by a third party, a manager, or a marketing director. Additionally, in accordance with one or more further embodiments of the present invention, Orders may require different approvals according to various criteria such as, for example and without limitation, marketing or legal approval, or simply a second individual to approve a submission from a first individual. In general, in accordance with one or more embodiments of the present invention, Approval Workflow enables rules to be imposed regarding Orders before such Orders are submitted for production. Thus, whenever such Approval Workflow rules are imposed, further processing of the submitted Order will cease until the rules criteria are met. For example, an Order will be routed via e-mail to each person in the Approval Workflow for approval in accordance with any one of a number of methods that are well known to those of ordinary skill in the art. If the Order Approval Workflow has not been completed within a predetermined amount of time (for example and without limitation, 96 hours), then the Order might be cancelled automatically. The Order will become a Job, and be sent to a Production Center, only when the required approval conditions have been met. When that happens, the client will be notified via e-mail. Control is then transferred to Step 3104 shown in FIG. 3.

At Step 3104 of FIG. 3, the information generated from the various steps is gathered from local storage in one of Web Application Servers 1201-120n and/or Data Store 1002, and an inventory of all resources used to form Submitted Order 3105 is saved (i.e., the Document Template to be used, all options selected as part of the Order, the Data Template, and the Data List (i.e., the audience member list) are stored in Database 1002). In accordance with one or more embodiments of the present invention, because, for example and without limitation, Documents in Document Library 3100 may be updated or removed by other users of System 1000 (including, for example and without limitation, administrators), local copies, or snapshots, of the resources selected by the client are made—i.e., a “carbon copy” of the information is made, and referenced to an Order, which carbon copy cannot be changed. In this manner, updates to Document Library 3100 or List Library 3101 may be made without adversely affecting currently submitted Orders. Lastly, in accordance with one or more embodiments of the present invention, an Order Template, i.e., information related to an Order in progress, may be saved. Thus, all selections made during Order process 3000 are saved into a new Order Template, and the new Order Template can be used by a client to start a new Order.

In accordance with one or more embodiments of the present invention, a client may designate an Order as a Recurring Order—non-Recurring Orders go into production only once, but Recurring Orders go into production repeatedly with a frequency set by the client. In addition, the client can select a recurring frequency, and a date on which the Order will stop recurring.

Production Process Overview

To appreciate the benefits derived from use of System 1000, it is useful to understand that printed materials are produced en masse. In addition, most printed materials are printed at facilities that used large format paper to print multiple pieces on a single sheet of the large format paper. The individually printed pieces are then cut from the large sheets, and the cut pieces are sorted. In many cases, the cutting process is performed on multiple large sheets that are stacked, one on top of another. It is also important to note that pieces from one Job may be printed on a sheet of paper alongside pieces from a different Job that originates from a different client to make efficient use of the printing process. Such arrangements of disparate printed materials minimize waste and delays.

As previously described, a client provides information that specifies a message campaign. The information is typically provided by presenting the client with a series of menus and by presenting successions of steps through a web based interface using a Web Browser. The culmination of carrying out these steps is a collection of data that represents an Order for a message campaign, i.e., an order for sending mailings to a list of audience members that will be processed by System 1000. Once the information required for the message campaign has been collected, System 1000 begins a series of tasks designed to increase the efficiency and timeliness of Order fulfillment. In accordance with one or more embodiments of the present invention, these steps can include subdividing particular tasks, combining subdivided tasks, reordering tasks, and assigning tasks to specific Production Centers for Order fulfillment. As a result, System 1000 typically produces, as output, information in the form of files, in one or more formats that can be utilized by one or more Production Centers to produce the messages. System 1000 advantageously divides, combines, and shuffles tasks between Production Centers for greater efficiency and timeliness. This process is described below.

FIG. 4 shows a flow diagram of a Production process that takes a Submitted Order for a message campaign to mailing, which Production process is fabricated in accordance with one or more embodiments of the present invention. As will become clear from the description below, a Production process fabricated in accordance with one or more embodiments of the present invention enables: (a) flexibility and automation at multiple stages of production; and (b) assignment of sub-tasks from multiple Orders to multiple resources at disparate locations, for example, Production Center 1001, Production Center 1002, and Production Center 1003 shown in FIG. 4. For purposes of illustration, the Production process is divided into four (4) phases: (a) a Submitted Phase, (b) a Pending Phase, (c) a Production Phase, and (d) a Completed Phase.

In accordance with one or more embodiments of the present invention, an Order, and the information needed to complete the Order, are stored in Database 1002 and Network File Server 1001 as a Job. Typically, Submitted Jobs have a particular production deadline by which they must be completed. However, for the sake of efficiency, Submitted Jobs may be accumulated so they can be combined for greater efficiency and for reducing costs due to larger production runs at external print service providers. As such, in accordance with one or more embodiments of the present invention, aggregating sub-tasks among Jobs enables combining Print Jobs into batches of sizes designed to provide efficient combinations. Further, the more Print Jobs that accumulate, the greater is the possibility for providing efficient combinations.

Submitted Phase: In accordance with one or more embodiments of the present invention, whenever a Job enters the Submitted Phase, the current date and time are checked against a schedule date of the Job (as was described above, during the Order process, a schedule date for the Order is set by the client). For example, no further processing of a Job occurs until after 12:00 AM on the Job's schedule date. In accordance with one or more embodiments of the present invention, the schedule date can be the current day, but only if the Job is submitted before a production cut-off time (the production cut-off time determines the time of day past which Submitted Orders cannot be scheduled for production on the same day they are submitted—any Orders submitted past this time will be scheduled no earlier then the next available day). The schedule date can also be a future date, up to but not exceeding, a scheduling advance (i.e., a maximum number of days ahead that an Order can be scheduled for production after the current date). Thus, when creating an Order, the client selects a day when the Order will go into production. The date range of days that are available for selection are governed by the production cut-off time (this determines the first day selectable), the scheduling advance (this determines the last day selectable and the number of days), and Holidays configured (Holidays that fall within the date range are not selectable). Both the production cut-off time and the scheduling advance are configured by an Administrator.

Depending on the schedule date and the production cut-off time, processing of the Submitted Job may begin immediately (if schedule date=current date, and the Job is submitted before the production cut-off time), or processing of the Submitted Job may be delayed for days (if a future date was selected for the schedule date). However, once processing of a Submitted Job resumes, System 1000 uses several factors to assign each piece in a Job to a Production Center best suited to manufacture and mail that piece. To be considered, a Production Center must: (a) be available for use by the client; (b) be up and accepting Print Jobs (i.e., status=‘Up’); (c) have one or more working Printers (i.e., status=‘Up’) which can handle the Product Type, Print Type, and Paper Types required by the Job; (d) must have a sufficient quantity of all durable Resources (i.e., Paper Types, Envelopes, and Inventory Items) required for the Job. If no Production Center qualifies for a Job, then the Job is put ‘On Hold.’ In accordance with one or more embodiments of the present invention, the Job remains in ‘On Hold’ status until a suitable Production Center can be created, an exiting one modified, or the Job is cancelled. Of those Production Centers that do qualify, Zip Code Routing and Production Center Priority are used to select the best Production Center for each piece in the Order. First, Zip Code Routing assigns each piece in the Job to a Production Center with the highest priority for the Zip Code used in a piece's recipient address (or the Zip Code in the shipping address if all pieces are mailed to the same location). Zip Routing Priorities are configured for each Production Center by an Administrator. However, if there is no such configuration, all Zip Codes have the same priority by default, making Zip Code Routing superfluous. At this point, multiple Production Centers may qualify for a piece because: (a) multiple Production Centers have the same Zip Code Priority for a piece's Zip Code; (b) Zip Code Routing priorities where not configured for a piece's Zip Code; or (c) a piece has an international address. If multiple Production Centers qualify for a piece, then Production Center Priority is used to determine which of the qualifying Production Centers gets assigned the piece. Like Zip Code Routing Priorities, Production Center Priorities are assigned by an Administrator for each Production Center. As shown in FIG. 4, Client Job 100, Client Job 101, and Client Job 102 represent Submitted Orders that have been assigned to Production Centers 1001, 1002, and 1003, respectively.

In accordance with one or more embodiments of the present invention, whenever a single Job comprises a Data List containing between fifty and hundreds of thousands of entries, the outgoing messages are typically split into sub-tasks. Thus, after all pieces have been assigned to Production Centers, in accordance with one or more such embodiments, the pieces for each Production Center are split into Split Jobs based on each piece's Mail Class (for example, 1^{st} class, 3^{rd} class, and so forth). A single Job may require use of multiple Mail Classes because address attributes of the pieces in a Job can vary. International addresses, for example, use a Mail Class suited for international postage costs, while addresses within the United States may qualify for Sorted or Unsorted mail rates depending on the validity of each piece's recipient address. Advantageously, splitting Jobs in this manner decreases delivery time for finished mail pieces. For example, as shown in FIG. 4, Client Job 300 is split into Split Jobs 400 and 401; and Client Job 301 is split into Split Jobs 402, 403, and 404. As further shown in FIG. 4, Split Jobs 402, 403, and 404 are targeted for completion at Production Center 1001, Production Center 1002, and Production Center 1003, respectively. Once a Job is divided into groups by Production Center and Mail Class, the Job enters the Pending Phase.

The above-described process can be understood by considering the following example. Assume that Client Job 301 consists of a mailing to a target audience dispersed across the United States. If Production Centers 1001, 1002, and 1003 were located in the eastern, central, and western United States, respectively, the job of printing and mailing materials from User Job 101 would be divided according to delivery address so that target audience members would receive mailings produced and mailed from the closest Production Center available. Such allocation of jobs advantageously saves money and reduces delivery times.

Pending Phase: In accordance with one or more embodiments of the present invention, during the Pending Phase, pieces from other Jobs are merged into these groups if: (a) the pieces being merged all have the same Product Type, use the same Resources, and use the same Mail Class; and (b) application of one or more Merge Rules (which can be created and/or edited by an Administrator) qualifies the pieces to be merged. Merge Rules allow pieces with predetermined attributes to be merged that normally would not be merged. Merging occurs to improve efficiency, allowing a larger number of pieces to be manufactured at once. In accordance with one or more embodiments of the present invention, Service Processors 1401-140j of System 1000 shown in FIG. 1 execute software that combines Split Job 402 derived from Client Job 301 with Split Jobs 400 and 401 derived from Client Job 300 to form a single merged job, Merged Job 501. As shown in FIG. 4, Merged Job 501 is destined to be processed at Production Center 1001. As further shown in FIG. 4, Split Job 403, derived from Client Job 301, proceeds to the Production Phase as an individual job, i.e., as Production Job 502. As further shown in FIG. 4, Split Job 404 derived from Client Job 301 is combined with Whole Job 405 (an undivided version of Client Job 302) to form Merged Job 503. As one can appreciate from the above, during the Pending Phase, Split Jobs are combined to increase efficiency, timeliness, or other criteria.

Pieces from Split Jobs continue to be merged until one of the following conditions is met: (a) a Wait Threshold for a Production Center in question is met (i.e., the pieces have been accumulating for more then a pre-defined amount of time); (b) a Merge Threshold for the Production Center in question is met (i.e., a number of pieces in a Merged Job has reached a pre-defined limit for this Production Center); or (c) an Administrator accelerates the Job. Once one of the above conditions is met, the group of pieces becomes a Print Job, and transitions to the Production Phase. However, if Presort is enabled for a Production Center (for example, Presort 601 at Production Center 1001 and Presort 602 at Production Center 1002, but none at Production Center 1003), then the pieces in each Print Job assigned to that Production Center are sorted by Zip Code before going into the Production Phase. For example and without limitation, in accordance with Zip Code Routing, mailings destined for east coast, west coast, and central United States addresses are handled by east coast facilities, west coast facilities and central United States facilities, respectively. Then, after printing, pre-sorted pieces are sorted via automated machinery into different bins according to their Zip Codes for delivery to a selected mailing service. Most mailing services provide a discount for mail that is delivered to them pre-sorted. As such, the Presort process provides mailing cost savings.

In accordance with one or more embodiments of the present invention, merging and sorting is done on files having records represented in XML format, although further embodiments exist which use any other suitable data representation.

Production Phase: In accordance with one or more embodiments of the present invention, once a Print Job is in the Production Phase, a Printer at the Production Center is selected to manufacture the pieces in the Print Job, and a print file is generated. However, prior to generating a print file, in accordance with one or more embodiments of the present invention, automatic impositioning is carried out to enable disparate Jobs from different clients to be placed on the same printed page for more efficiency in the printing process. The impositioning process is controlled by criteria such as, for example and without limitation: (a) Mail Class; (b) product Color options (for example and without limitation, black and white versus color); (c) Product Type; (d) type of Paper; (e) type of Envelope; (f) number of pages contained in a Document; (g) whether or not a Document uses double sided or single sided printing; and (h) whether or not the Document uses “Full Bleed” or “No Bleed” printing. Such impositioning in accordance with one or more embodiments of the present invention provides several benefits. For example, lower cost and higher throughput printing, reduced mailing costs, and ability to utilize printing vendors that provide lower pricing.

Next, the print file is transferred to a physical Production Center in accordance with any one of a number of methods that are well known to those of ordinary skill in the art such as, for example and without limitation, FTP, Secure FTP, or e-mail. At this point, control of the Print Job in System 1000 is transferred to the Production Center.

The preparation and delivery of the print file is shown as follows in FIG. 4: Merged Job 501 at Production Center 1001 undergoes Rip and Delivery step 701; Production Job 502 at Production Center 1002 undergoes Rip and Delivery step 702; and Merged Job 503 at Production Center 1003 undergoes Rip and Delivery step 703. In accordance with one or more embodiments of the present invention, a Rip and Delivery step comprises: (a) rasterizing images into PDF or other formats that are then used in the actual creation of printed or electronic materials; and (b) sending the file through FTP (“file transfer protocol”), SFTP (“SSH File Transfer Protocol”) or other mechanism to the printer.

At the Production Center, a Production Manager ensures the Print Job manufacture proceeds to completion. To assist the Production Manager manage and track the status of Print Jobs, System 1000 enables a Production Workflow to be defined for each Product Type in accordance with any one of a number of methods that are well known to those of ordinary skill in the art—Production Workflows are defined for each Product Type by an Administrator. Each Production Workflow defines a number steps that a Print Job passes through during manufacture (such as, for example and without limitation, ‘Printed’, ‘Cut’, ‘Folded and Inserted’, and so forth)—the various steps may differ according to the types of materials being produced, and the specifications provided to the Production Center. A Production Manager monitors the status of each Print Job, and advances its status in System 1000 to a next step in the Production Workflow as each step is completed. The Production Workflow ends with all pieces in the Print Job having been delivered for mailing. Use of Production Workflows is optional. The default Production Workflow defined for each Product Type is empty, i.e., it contains no steps between ‘Ready’ and ‘Completed’. When a Print Job has been manufactured, and has been delivered for mailing, the Production Manager advances the state of the Order to ‘Completed’.

The Production Workflow is shown as follows in FIG. 4: Production Workflow steps 801, 802, and 803 update production status reports. In accordance with one or more embodiments of the present invention, these production status reports relating to the Jobs are stored in Database 1002. These data indicate progression through the Production Workflow so that the status of a Job may be tracked in real-time from any location with access to System 1000.

Once all of the Print Jobs originating from a Submitted Order have been advanced to ‘Completed’, System 1000 marks the Order as ‘Completed’. This is shown in FIG. 4 as Completed Job steps 901, 902, and 903.

As shown in FIG. 4, in accordance with one or more embodiments of the present invention, processing of Merged Jobs (for example, Merged Jobs 501 and 503) and Production Jobs (Production Job 502) can occur in parallel at different Production Centers is according to the specific service task types required for the Print Jobs.

Completed Phase: During the Completed phase, a notification e-mail is sent to clients notifying them that their Order is complete. Billing is performed in some instances, and the information about the Job state is modified to show it has been completed, i.e., Database 1002 is updated.

In accordance with one or more embodiments of the present invention, as a Job progresses through the above-described phases, in accordance with criteria set by an Administrator using any one of a number of methods that are well known to those of ordinary skill in the art, e-mail notification of a Job's status may be sent to any number of people, including the client that submitted the Job.

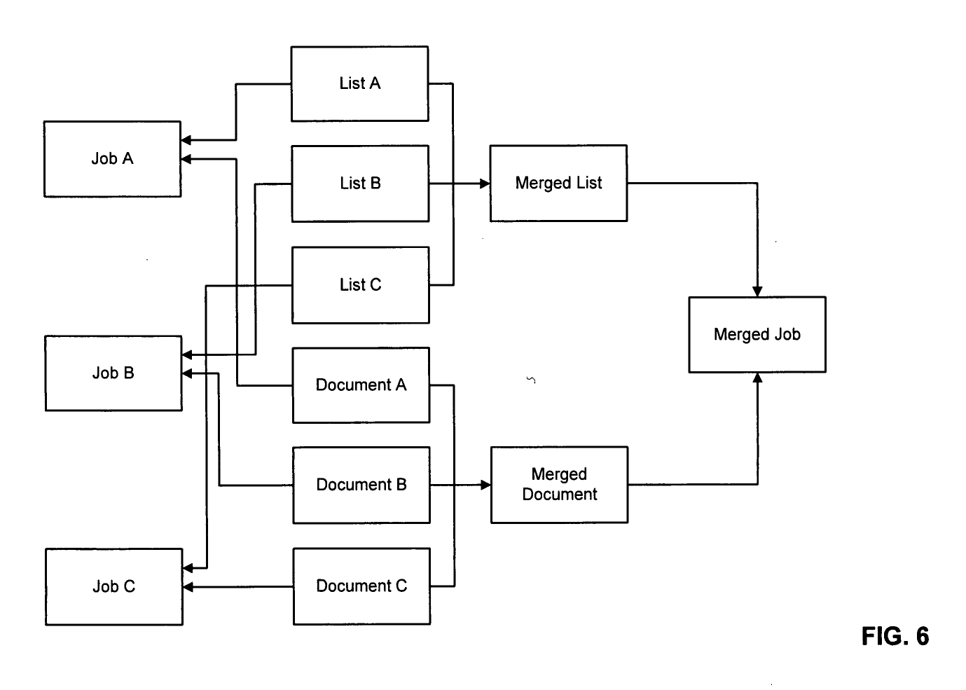

FIG. 6 shows a block diagram that helps illustrate how Merged Jobs shown in FIG. 4 are provided in accordance with one or more embodiments of the present invention. As shown in FIG. 6, Job A refers or points to Document A and associated Data List A; Job B refers or points to Document B and associated Data List B; and Job C refers or points to Document C and associated Data List C. As further shown in FIG. 6, List A, List B, and List C are merged into a Merged List, and Document A, Document B, and Document C are merged into a Merged Document (where the Merged Documents is a list of Documents A, B, and C). In accordance with one or more embodiments of the present invention, each record in the Merged List refers or points to the appropriate one of Documents A, B, and C in the Merged Document. Further, as shown in FIG. 6, a Merged Job refers or points to the Merged Job and the associated Merged Document.

Document Rendering

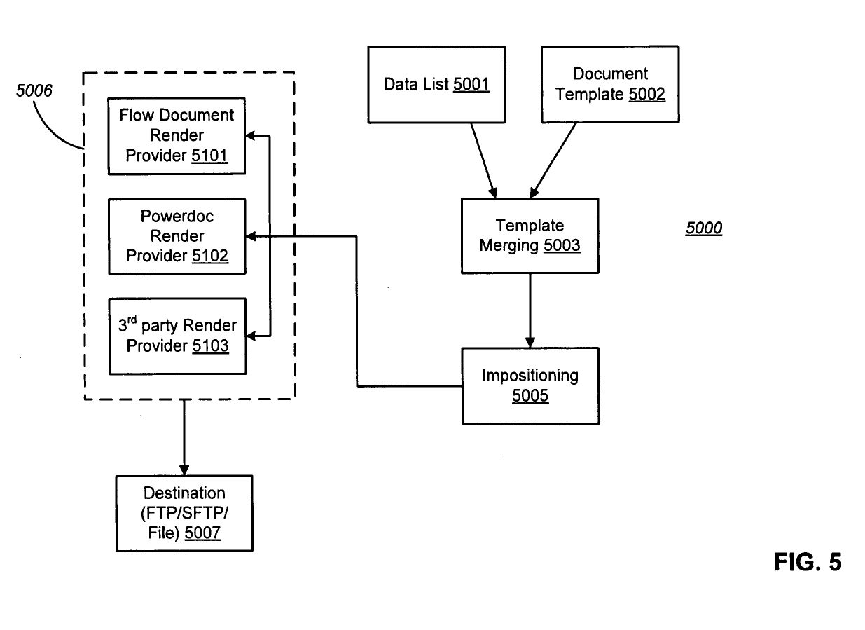

FIG. 5 shows a block diagram of Rendering process 5000 that is fabricated in accordance with one or more embodiments of the present invention. As shown in FIG. 5, Rendering process 5000 creates individual messages in a message campaign from Data List 5001 and Document Template 5002. As was described above, Rendering process 500 is performed utilizing one or more of Service Processors 1401-140j and Rendering Engine 1006.

As shown in FIG. 5, at Template Merging step 5003: (a) a data record representing an audience member is obtained from Data List 5001; and (b) information from the data record is combined with Document Template 5002 to provide combined data for use in Rendering step 5006. As was described above, a Data Template associated with Document Template 5002 enables the relevant information to be extracted from the data record and to be placed in an appropriate position in Document Template 5002. Control is then transferred to Impositioning step 5005 of FIG. 5.

It should be understood that for maximum efficiency of printing, a multiplicity of the created messages might be combined to form a format consisting of a multiple message, perhaps in a mosaic. The process of combining multiple messages to create a single larger image is referred to herein as impositioning, and is carried out at Impositioning step 5005 shown in FIG. 5. The process of impositioning maximizes the number of messages printed on a single sheet of paper. For example, the orientation of individual messages during impositioning may be changed, or in the case of two-sided printing, front-back orientations may be altered so that fewer printing steps are required on one side of the two-sided material—in general, any imposition will reduce the printing steps required. Further, in accordance with one or more embodiments of the present invention, stacking impositioning is performed to attempt to reduce finishing steps. Advantageously, stacking impositioning positions messages such that when the mail pieces are printed and cut, they will be in the correct order.

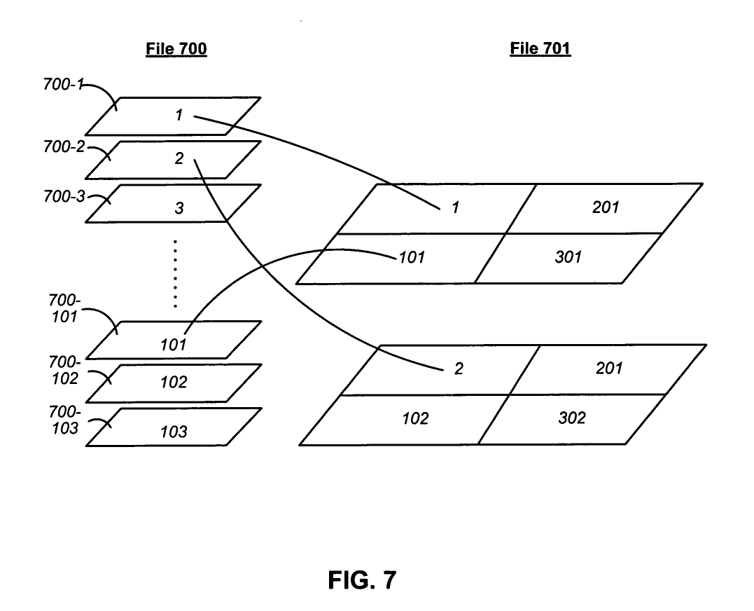

In accordance with one or more embodiments of the present invention, impositioning is done, for example and without limitation, using XML representations of pieces. This is advantageous in that impositioning in this manner does not involve working with large files in print ready format. To understand this better, refer to FIG. 7 which illustrates an impositioning process that is fabricated in accordance with one or more embodiments of the present invention. As shown in FIG. 7, records 700-1, 700-2, 700-3, . . . 700-101, 700-102, 700-103 of File 700 represent individual print pieces for a message campaign (although embodiments are not thusly limited, assume for sake of understanding this process that each piece has only one page). In accordance with one or more embodiments of the present invention, these records use XML representations of layouts of the pieces, although further embodiments exist which use any other suitable layout representation. As further shown in FIG. 7, records 701-1, 701-2 of File 701 represent large paper print pieces for the message campaign after impositioning. In accordance with one or more embodiments of the present invention, these records also use XML representations of the layout of the larger print pieces, although further embodiments exist which use any other suitable representation. As one can readily appreciate from FIG. 7: (a) record 701-1 of File 701 includes data from records 700-1, 700-101, 700-201, and 700-301 of File 700; and (b) record 701-2 of File 701 includes data from records 700-2, 700-102, 700-202, and 700-302 of File 700. As one can appreciate from FIG. 7, cutting a group of large papers printed using File 701 will provide stacks of pieces that are grouped in a predetermined manner. Further, in light of this description, one of ordinary skill in the art would be able to convert the XML representations of records in File 700 to XML representations of records in File 701 routinely and without undue experimentation. Thus, in addition, in accordance with one or more embodiments of the present invention, output from Impositioning step 5005 is a file with records using XML representations of layouts of printable images (each of which is a mosaic of messages contained on one or a series of single print sheets). Control is then transferred to Rendering step 5006 of FIG. 5.

As shown in FIG. 5, Rendering step 5006 may include use of one or more rendering programs such as, for example and without limitation, Flow Document Render Provider 5101, Powerdoc Render Provider 5102, or third party Render Provider 5103 (where third party Render Provider 5103 may include, for example and without limitation, Adobe® Indesign® Server page layout software, Quark® Dynamic Document Server, and the like). In accordance with one or more such embodiments, output from Rendering step 5006 comprises information in digital format that can be used to produce or print a single message targeted to a specific audience member. Control is then transferred to Destination step 5007 of FIG. 5.

At Destination step 5007 shown in FIG. 5, the digitally formatted output is transferred to a printing facility using any one of a number of methods that are well known to those in the art for transferring digital information such as, for example and without limitation, File Transfer Protocol (FTP), Secure File Transfer Protocol (SFTP), file uploading, or e-mail.

Generating Message Campaigns Using Web Sites to Capture Audience Responses:

In accordance with one or more embodiments of the present invention, a client may create hosted, personalized web pages using, for example and without limitation, HTML replacement and generation that enables insertion of dynamic imagery driven by business rules on a per-page basis that are fully integrated in both content and data with other message campaigns across different communication channels. Further, in accordance with one or more such embodiments, responses from audience members (for example and without limitation, recipients of messages from other message campaigns such as mail campaigns) are automatically captured and transmitted back to the original database (for example, a Data List used to create the other message campaigns) for clients to compile, analyze, and use in creating future message campaigns. For example, in accordance with one or more embodiments of the present invention, dynamic URLs are created which may be based on predetermined parameters of audience member data such as, for example and without limitation, http://www.companyname.com/firstname.lastname.html. Of course, it should be appreciated that further embodiments exist wherein Flash may be used as well as HTML.

To carry out such web assisted message campaigns, in accordance with one or more embodiments of the present invention, the client: (a) creates an HTML template (in the manner described below); and (b) creates the web campaign. In accordance with one or more such embodiments, this associates a list of audience members in a Data List with the HTML template and a URL template such as, for example and without limitation, httl://abc.com/<first name>.<last name>. In particular, whenever the web campaign is published, System 1000: (a) expands the URL template for each of the audience members in the Data List to form a list of URLs (each of which is associated with the HTML template to use in the web campaign); and (b) saves each URL in a database (“a URL database”) that is stored in Database 1002. This associates each URL with an audience member and the HTML template to use. In accordance with one or more such embodiments, whenever someone visits a web site with a web browser using a URL, System 1000 accesses the URL database to determine if the URL is related to a web campaign. If it is, System 1000: (a) retrieves information relating to the associated audience member and the associated HTML template; (b) merges them to form audience-member-specific HTML content; and (c) presents that content to the web browser. In accordance with one or more embodiments of the present invention, audience members would access a Web Publication Server of System 1000 (for example, the Web Publication Server may be one of Web Application Servers 1201-120n shown in FIG. 1 or a dedicated server). Further, the Web Publication Server would interact with one of API Servers 1301-130m shown in FIG. 1 to obtain access to the URL database and associated links to other files in Database 1002 such as, for example, Data Lists.

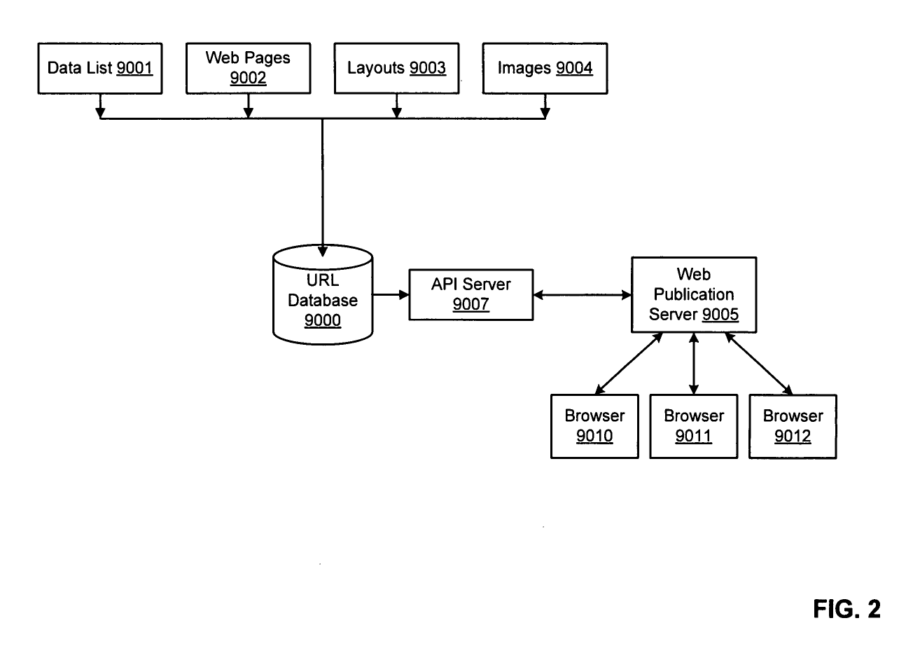

FIG. 2 shows a block diagram of components of System 1000 that are used to web site interaction for capturing audience responses. As indicated in FIG. 2, when the web sites are published, URL database 900 stores the individual URLs—the individual URLs are associated with a Data List from Data List file 9001 and a web page from Web Page file 9002. Further, a particular web page may be associated with Layouts from Layout file 9003 and Images from Image file 9004. As further shown in FIG. 2, whenever an audience member contacts Web Publication Server 9005 over the Internet, Web Publication Server 9005 interacts through API Server 9007 to: (a) verify the request (reference to URL database 9000); (b) present the web page (reference to a file in Web Pages 9002—substituting any variables from a file in Data List 9001, Layouts 9003, and/or Images 9004); and (c) interact with the audience member to gather and record information (for example and without limitation, to store responses and/or update tracking information).

In accordance with one or more embodiments of the present invention, audience-member-specific content may be presented, for example and without limitation, by using an HTML template that contains placeholders in the form of tags such as, for example and without limitation, {first_name}. Then, in accordance with one or more embodiments of the present invention, these tags are merged with the audience-member-specific information during the merging process. In addition, in accordance with one or more embodiments of the present invention, the HTML template can also contain additional logic control blocks written in any one of a number of script languages that are well known to those of ordinary skill in the art that is interpreted by System 1000 using any one of a number of methods that are well known to those of ordinary skill in the art. Non-limiting examples of such script language include <%if Sex=“Male” then %> Him <% else %>Her <% endif%>. In further addition, in accordance with one or more embodiments of the present invention, the HTML template can also dynamically generate images or documents by incorporating Image or Document template hyperlinks in the same manner described above in regard to mail messages. As a non-limiting example, if the HTML template contains a Document template hyperlink like <img src=“?document_name=Hello” />, in accordance with one or more embodiments of the present invention, System 1000 will: (a) retrieve a Document template named ‘Hello’; (b) merge it with current audience information; and (c) render it as a bitmap page back to the web browser. Advantageously, this may enable detection of collisions in name space used to drive URL addresses since duplicate names will be shown as an error. In response, System 1000 may update the names, and can optimally allocate names such as jsmith, johnsmith, jsmith_{—}1, and so forth. For this reason, and in accordance with one or more embodiments of the present invention, System 1000 pre-allocates the URLs, but does not build the web pages. Then, upon web page access, the URL links to all data about the audience member, and builds a dynamic page “just in time.” Advantageously, in accordance with one or more embodiments of the present invention, this method presents web pages using the latest audience data in a Data List.

In accordance with one or more embodiments of the present invention, a client creates a message campaign, for example, a mail campaign, that indicates a web site having a personalized URL address to use for making a response. Then, members of the targeted audience for the message campaign receive the messages, and respond by visiting web sites using the personalized URLs indicated in the messages. Next, as System 1000 supports the interaction for this visit, it can: (a) collect tracking information such as, for example and without limitation, time of interaction, and visitor web address, and information input from the visitor in response, for example and without limitation, queries presented to the visitor, and so forth, and (b) associate and store the collected (i.e., response) information with or associated with audience member records in Database 1002, for example, in the Data List. Then, the client can analyze the collected (i.e., response) information using any number of rules or heuristics to create follow-up message campaigns having messages in the same or different form in the manner described above. Advantageously, in accordance with one or more embodiments of the present invention, collection of information across different message campaigns enables detailed analysis of responses, sales, and lack of responses. Such detailed analysis of message campaigns, audience responses, and messages themselves enables clients to obtain unique insights into response triggers for potential customers, and increases the effectiveness of advertising efforts for users of System 1000.

In accordance with one or more embodiments of the present invention, web site publishing enables an HTML template to be merged with information from a Data List to be published onto a web site. Designing web pages includes creating an HTML template with resources created within System 1000 (for example, Layouts and Images), and resources (for example, HTML files) created outside of System 1000. HTML files created outside of System 1000 can be uploaded to a client's custom folder in System 1000 using, for example and without limitation, FTP. Once all the necessary resources are present in System 1000, the client can navigate to a “Create Web Site” where he/she will: (a) provide a name for the web site; (b) select an HTML template file, for example, out of those previously uploaded, that he/she wishes to use as a starting page (to do this, the client may be presented with a drop down list of HTML templates; (c) select a Data Template he/she wishes to associate with the web site; (d) select Layout(s) he/she wishes to use (one may create a web site without any layouts); and (e) select Document(s) he/she wishes to use (one may create a web site without any Documents). In order for a client to design web sites that can be personalized, the web pages must use special tags to mark personalized areas. First, in accordance with one or more embodiments, the web pages need to end with an .htm or .html extension. Second, any part of the web pages that needs to be replaced with a personalized field, should be tagged with {field name}—System 1000 will replace the tag with the actual value of the field name. This can be used in any text area, text boxes, drop down lists, even Javascript, or basically anywhere in the web page. If the field is a template column, the client should provide a closing tag {/field name}. In such a case, content between the {field name} and {/field name} will be repeated for as many rows as there are rows in the template column. The field name must be a fully qualified field name. For example, to refer to a field ‘name’ in the client's template field, the client should use the following tag {client.name}. A client can also add conditional blocks. {if:field name} . . . {endif:field name} form a conditional block that will process content inside the block if field name evaluates to “true”. Otherwise, content inside the block will not be shown. As was described above, web pages can update values back to System 1000. To do so, any values that need to be updated should be part of the HTML template and can reside in text boxes, drop down lists, hidden fields, and so forth. The template should have a button or hidden field named ‘_action’ with a value of 'save’. The template's action should be a POST, and it should POST to either itself or another personalized web page on the server. The server will automatically update the posted personalized data. If the page is currently not associated with a particular record, the POST will create a new record and associate the rest of the session with that newly created record. In accordance with one or more embodiments of the present invention, a client can also direct audience members to a static URL, and use lookup functionality to associate a particular audience member with a particular record in a Data List. To do this, a column name to look up should be in a template element named ‘_lookup_name’ and a column value to look up should be in a template element named ‘_lookup_value’. The template element ‘_action’ should have a value of ‘lookup’. In both the save and lookup actions, one can use two template elements called ‘_success_page’ and ‘_error_page’ that contains a URL for System 1000 to redirect to on successful completion or failure of the operation, respectively. In accordance with one or more embodiments of the present invention, a client may use Layouts and Documents in the web pages. To use a Layout in a web page, a client would use the following URL for publication: ?type=png&layout_name=<layout_name>—for example, <img width=“500” height=“500” src=“?type=png&layout_name=Main layout” />. If a client is using a Layout directly from another web site (such as an email or another web site), the client would use the following <URL for publication: ?type=png&layout_name=<layout name>—for example, if a publication URL is http://ashish.abc.12solutions.com, <img width=“500” height=“500“src=htti):/ashish.abc.12solutions.com?type=png&layout_name=Main Layout“/>. Similarly, to use a Document, use the following URL: ?type=png&document_name=<document_name>&page_no=<page to show>(page number starts with 1). One can also display bitmaps of variable columns of Layout and Images. To do so, the client would use the following URL for publication: ?type=png&column_name=<column_name>. Finally, one can utilize a PDF of a Document with the following URL: ?type=pdf&document_name=<document name>. Sometimes, however, it is advisable to add an &.pdf to the end of the URL because some browsers will not open a PDF file unless the link ends with a .pdf. The URL should be: ?type=pdf&document_name=<document name>&.pdf. Finally, System 1000 will save the web page information in a web site database in Database 1002. Further, in accordance with one or more embodiments of the present invention, web sites are previewed in a manner identical to that described above for Documents.

In accordance with one or more embodiments of the present invention, web publishing, i.e., the process of putting a web site online via System 1000, begins with the client's selecting a ‘Publish Web Site’ Order he/she would for do in submitting an Order for a mail message campaign. This will start the following web publication workflow process. First, the client is directed to a page where publication options are selected. These publication options include the following: (a) a web site to be employed (this is selected from a drop down list of web sites currently available to the client); (b) a Data List to be used; (c) a date and time the client wants the publication to become available or whether the client wants the publication to be available immediately; (d) a date the client wants the publication to be taken offline or whether the publication will be available indefinitely until manually taken down; and (e) URL(s) the client wants the publication to appear on (for example; the client can write an expression, or the client can use pre-defined templates such as, for example and without limitation, (i) HTTP://[server name]/[field A], or (ii) HTTP://[server name]/[field A] . [field B] where [server name] is a text box pre-populated with the URL of a server the client is currently on, and [Field A] and [Field B] are drop down list of fields.). In accordance with one or more such embodiments, web publications previously published will appear on a client's Order history page. Further, a client can switch between regular print Orders, Recurring Orders and web publications. Each publication's name will be selectable, redirecting the client to a page containing the publication's information, much like that available for mail orders. As those of ordinary skill in the art can readily appreciate, publication dates for web sites must include a sufficient time to submit the URL to DNS (“Domain Name System”) and for DNS to recognize them.

In accordance with one or more embodiments of the present invention, when a client submits an Order for a web publication, System 1000 iterates through a Data List, and builds a URL for each list item by evaluating the URL expression, makes a copy of the web site (to freeze against edits); and inserts the URLs into the URL database.

The embodiments of the present invention described above are exemplary. Many changes and modifications may be made to the disclosure recited above while remaining within the scope of the invention. As such, the scope of the invention should therefore be determined not with reference to the above description, but instead, should be determined with reference to the appended claims along with their full scope of equivalents.

What is claimed is:

1. A method for managing a message campaign that comprises:
creating one or more messages to be sent to one or more members of a target audience for the message campaign, wherein: the one or more messages comprise address information to be used to provide a response, the address information includes a web address, and creating includes impositioning using XML representations of messages;
interacting with one or more members of the target audience that respond to a received message using the web address to obtain response information, including tracking information; and
associating the response information with the responsive members and storing the response information.

2. The method of claim 1 which further comprises:
analyzing audience information, including response information, selecting a further target audience, and creating one or more further messages to be sent to one or more members of the selected further target audience.

3. The method of claim 2 wherein the web address includes predetermined target audience member information.

4. The method of claim 3 wherein the predetermined target audience information includes a first name and a last name.

5. The method of claim 4 wherein analyzing the audience information comprises using rules or heuristics.

6. The method of claim 5 wherein creating further messages comprises creating one or more follow-up message campaigns having messages in a different form from messages in the message campaign.

7. The method of claim 1 wherein the web address for each message is identical.

8. The method of claim 1 wherein creating comprises:
creating a web page template;
associating a list of target audience members with the web page template and a URL template;
publishing a web campaign by expanding the URL template for each member of the list of target audience members to form a list of URLs, each of which is associated with the web page template; and
saving each URL in a database that associates each URL with an audience member in the list and the web page template.

9. The method of claim 8 wherein creating the web page template comprises creating an HTML template.

10. The method of claim 9 wherein creating the HTML template comprises uploading HTML information.

11. The method of claim 8 wherein creating the web page template comprises creating an HTML template that contains placeholders for areas of the web page template in which specific target audience member information is to appear.

12. The method of claim 11 wherein one or more of the placeholders are tags.

13. The method of claim 11 wherein a placeholder is disposed in one or more of a text area, a text box, a drop down list, or Javascript.

14. The method of claim 11 wherein the HTML template includes one or more conditional blocks.

15. The method of claim 11 wherein the HTML template includes one or more logic control blocks written in a script language.

16. The method of claim 11 wherein the HTML template includes one or more hyperlinks to one or more templates.

17. The method of claim 8 wherein the URL template includes a placeholder for a last name of a target audience member.

18. The method of claim 8 which further comprises providing a date and time for web pages at the web addresses to become accessible.

19. The method of claim 8 wherein collecting information comprises:
in response to a web browser access request using a URL, accessing the URL database to determine if the URL is related to a message campaign; and
retrieving information relating to an associated target audience member and an associated web page template, merging to form specific target audience member web page content, and presenting the web page content to the web browser.

20. The method of claim 19 wherein merging comprises replacing one or more tags with target audience member content for the responder.

21. The method of claim 19 wherein collecting further comprises interacting with the responsive target audience member using the web browser interface to obtain response information.

22. The method of claim 21 which further comprises updating audience member information with the response information.

23. The method of claim 21 wherein:
the response information comprises tracking information and responses to queries disposed in one or more of the web pages; and
associating comprises associating and storing the response information with target audience member information.

24. A method for managing a message campaign that comprises:
creating one or more messages to be sent to one or more members of a target audience for the message campaign, wherein: the one or more messages comprise address information to be used to provide a response, and the address information includes a web address;
interacting with one or more members of the target audience that respond to a received message using the web address to obtain response information, including tracking information and further information;
associating the response information with the responsive members and storing the response information; and
analyzing audience information, including response information, selecting a further target audience, and creating one or more further messages to be sent to one or more members of the selected further target audience;
wherein:
the web address is based on predetermined target audience member information that includes information specific to a target audience member; and
creating comprises:
creating a web page template;
associating a list of target audience members with the web page template and a URL template;
publishing a web campaign by expanding the URL template for each member of the list of target audience members to form a list of URLs, each of which is associated with the web page template; and
saving each URL in a database that associates each URL with an audience member in the list and the web page template.

25. The method of claim 24 wherein creating the web page template comprises creating an HTML template.

26. The method of claim 25 wherein creating the HTML template comprises uploading HTML information.

27. The method of claim 24 wherein creating the web page template comprises creating an HTML template that contains placeholders for areas of the web page template in which specific target audience member information is to appear.

28. The method of claim 27 wherein one or more of the placeholders are tags.

29. The method of claim 27 wherein a placeholder is disposed in one or more of a text area, a text box, a drop down list, or Javascript.

30. The method of claim 27 wherein the HTML template includes one or more conditional blocks.

31. The method of claim 27 wherein the HTML template includes one or more logic control blocks written in a script language.

32. The method of claim 27 wherein the HTML template includes one or more hyperlinks to one or more templates.

33. The method of claim 24 wherein the URL template includes a placeholder for a last name of a target audience member.

34. The method of claim 24 which further comprises providing a date and time for web pages at the web addresses to become accessible.

35. The method of claim 24 wherein collecting information comprises:
in response to a web browser access request using a URL, accessing the URL database to determine if the URL is related to a message campaign; and
retrieving information relating to an associated target audience member and an associated web page template, merging to form specific target audience member web page content, and presenting the web page content to the web browser.

36. The method of claim 35 wherein merging comprises replacing one or more tags with target audience member content for the responder.

37. The method of claim 35 wherein collecting further comprises interacting with the responsive target audience member using the web browser interface to obtain response information.

38. The method of claim 37 which further comprises updating audience member information with the response information.

39. The method of claim 37 wherein:
the response information comprises tracking information and responses to queries disposed in one or more of the web pages; and
associating comprises associating and storing the response information with target audience member information.
